(19) United States
(12) Patent Application Publication
(10) Pub. No.: US 2026/0103638 A1
(43) Pub. Date: Apr. 16, 2026

(54) CHIRAL AGENT COMPOUND, CHOLESTERIC LIQUID CRYSTAL COMPOSITION COMPRISING CHIRAL AGENT COMPOUND AND USE THEREOF

(71) Applicant: SHIJIAZHUANG CHENGZHI YONGHUA DISPLAY MATERIAL CO., LTD., Shijiazhuang (CN)

(72) Inventors: Pengyao JU, Shijiazhuang (CN); Kaiyang DU, Shijiazhuang (CN); Hubo ZHANG, Shijiazhuang (CN); Xin WANG, Shijiazhuang (CN); Ming LI, Shijiazhuang (CN); Yantao MA, Shijiazhuang (CN); Peng LIU, Shijiazhuang (CN); Xinzhan SUN, Shijiazhuang (CN); Lulu WANG, Shijiazhuang (CN)

(73) Assignee: SHIJIAZHUANG CHENGZHI YONGHUA DISPLAY MATERIAL CO., LTD., Shijiazhuang (CN)

(21) Appl. No.: 19/340,252

(22) Filed: Sep. 25, 2025

(30) Foreign Application Priority Data
Sep. 27, 2024 (CN) 202411361860.8

(51) Int. Cl. C09K 19/34; C09K 19/12; C09K 19/18; C09K 19/20; C09K 19/30; C09K 19/32

(52) U.S. Cl. CPC C09K 19/3405; C09K 19/12; C09K 19/18; C09K 19/2007; C09K 19/3003; C09K 19/3068; C09K 19/32; C09K 2019/122; C09K 2019/183; C09K 2019/2035; C09K 2019/3004; C09K 2019/3077; C09K 2019/3083; C09K 2019/323; C09K 2019/3408

(57) ABSTRACT

The present invention discloses photosensitive chiral agent compound S, a cholesteric liquid crystal composition containing the photosensitive chiral agent compound S, and the use of the cholesteric liquid crystal composition in a liquid crystal display element and a liquid crystal display. The photosensitive chiral agent compound S has the properties of high HTP value, good solubility, and short switching time. The cholesteric liquid crystal composition comprising the photosensitive chiral agent compound S has high reflectance retention ratio, which ensures RGB color uniformity and does not require complicated pixel design; low viscosity, which ensures compatibility with existing large-scale panel fabrication processes; and fast UV-induced color switching speed, which results in reduced time during the UV process and lowered production costs. The photosensitive chiral agent compound S can be widely used in optical devices such as liquid crystal electronic books and outdoor and vehicle-mounted displays.

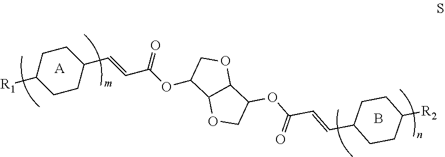

### CROSS REFERENCE TO PRIOR APPLICATION

This application claims priority to Chinese Patent Application No. 202411361860.8 (filed on Sep. 27, 2024), which is hereby incorporated by reference in its entirety.

### TECHNICAL FIELD

The present invention provides a novel chiral agent compound, a photochromic cholesteric liquid crystal composition as a material for a display element, and a display element using same, which are mainly applicable to the technical fields of liquid crystal electronic books, electronic signs, bistable liquid crystal displays, etc.

### BACKGROUND ART

In recent years, reflective displays (such as electronic paper, electronic books, smart cards and other products) are booming. In the application of electronic paper, compared with other display media, a cholesteric liquid crystal has better performance in both brightness and contrast and also the advantages of passive driving and easy production.

A planar state and focal cone state of the cholesteric liquid crystal are stable and can be maintained stable for a long term, thus exhibiting bistability. The cholesteric liquid crystal has Bragg reflection when in the planar state. The reflection wavelength (λ) is determined by the average refractive index (n) and chiral pitch (P) of a liquid crystal composition, with λ=n_{average}×P. When the refractive index of the liquid crystal composition is fixed, the chiral pitch P can be adjusted by increasing or decreasing the amount of the chiral compound, so as to obtain reflection wavelengths of different colors. At the same pitch, the wave width (Δλ) of the reflected light is directly proportional to the refractive index anisotropy (Δn=ne−no) of the liquid crystal. For a high brightness of reflection, it is necessary to use a liquid crystal composition with a large Δn.

Cholesteric liquid crystal compositions are used in cholesteric liquid crystal displays; however, a traditional cholesteric liquid crystal composition is composed of a nematic liquid crystal and a chiral additive. The fabrication of a light-rewritable cholesteric liquid crystal display requires the use of a photoresponsive chiral additive with a high helical twisting power (HTP). The photoresponsive chiral additive may undergo a photo-induced molecular configuration change in a nematic liquid crystal, leading to a change in the helical twisting power and thus a change in the pitch (P) of the cholesteric liquid crystal, thereby changing various reflected light colors. However, traditional cholesteric displays still have problems such as insufficient reflectance and colorization. Although a novel cholesteric liquid crystal composition is disclosed in the prior art documents such as CN 102464985 A, the cholesteric liquid crystal composition has relatively poor reflectance retention ratio and slow UV-induced color switching.

Cholesteric liquid crystal electronic books have high contrast and the advantage of zero power consumption in maintaining the displayed content and can replace paper in daily life. It is mainly used in electronic books, electronic tags, display panels, etc. At present, a cholesteric liquid crystal composition is obtained by adding an optically active chiral agent to a nematic liquid crystal. In the case of using the cholesteric liquid crystal for an electronic book, colorization is typically achieved by superimposing three cells, i.e., red, green, and blue cells. The three-layer stacking solution applied to achieve colorization requires thick and bulky liquid crystal cells, and the lower layer display shows light loss due to light scattering and refraction between layers, resulting in dim color display and low reflectance during three-cell colorization. In addition, liquid crystal cell stacking also has pixel alignment problems. In the prior art documents, such as CN 118308120 A, a technical solution that realizes colorization in a single-layer liquid crystal cell by using a photosensitive chiral agent is disclosed, that is, colorization is realized by irradiating a cholesteric liquid crystal containing a photosensitive chiral agent with varying UV light energy. However, the above solution also has problems and cannot be applied on a large scale. Although it can ensure an initial relatively high reflectance by means of a relatively high refractive index (generally 0.2 or more), the reflectance usually drops to a relatively large extent after UV-induced color switching (especially for the red color), which greatly affects the final color uniformity of the display panel and requires additional design of the sub-pixel size. In addition, it is usually difficult for an optically controlled chiral agent to achieve both a large HTP value and a fast UV-induced color switching speed. A low HTP value means requiring an increased amount of the chiral agent added, which results in an increased viscosity of the cholesteric liquid crystal, leading to incompatibility with an ODF process. A slow UV-induced color switching speed means requiring a longer technological process. Both of these may lead to a significant increase in the cost of the panel fabrication process.

Therefore, the technical problem to be solved urgently at present is to develop a chiral agent that simultaneously offers high HTP value, good solubility, and short switching time, and a composition that has relatively high reflectance retention ratio and simultaneously offers relatively low viscosity and relatively fast UV-induced color switching speed.

### SUMMARY OF THE INVENTION

The present invention provides a technical solution, which can solve the above technical problems.

Specifically, the present invention comprises a chiral agent compound selected from the following formula S,

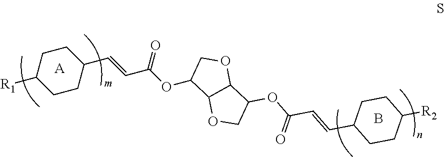

wherein
R₁ and R₂ each independently represent a fluoroalkyl group with a carbon atom number of 1-5, a fluoroalkoxy group with a carbon atom number of 1-5, a fluoroalkenyl group with a carbon atom number of 2-5, or a fluoroalkenyloxy group with a carbon atom number of 2-5;

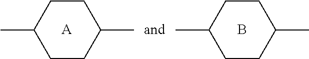

each independently represent

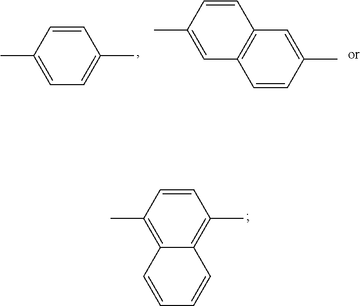

and any hydrogen of

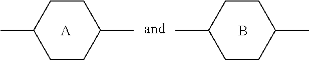

can be replaced by a halogen, an alkyl group with a carbon atom number of 1-10, an alkoxy group with a carbon atom number of 1-10, an alkenyl group with a carbon atom number of 2-10, or an alkenyloxy group with a carbon atom number of 2-10; and
m and n each independently represent 1 or 2.

Furthermore, the present invention provides a cholesteric liquid crystal composition, preferably the above-mentioned cholesteric liquid crystal composition, comprising one or more chiral agent compounds selected from chiral agent compounds represented by formula S.

Furthermore, the cholesteric liquid crystal composition of the present invention preferably further comprises one or more of chiral agent compounds represented by formulas SA1 to SA5,

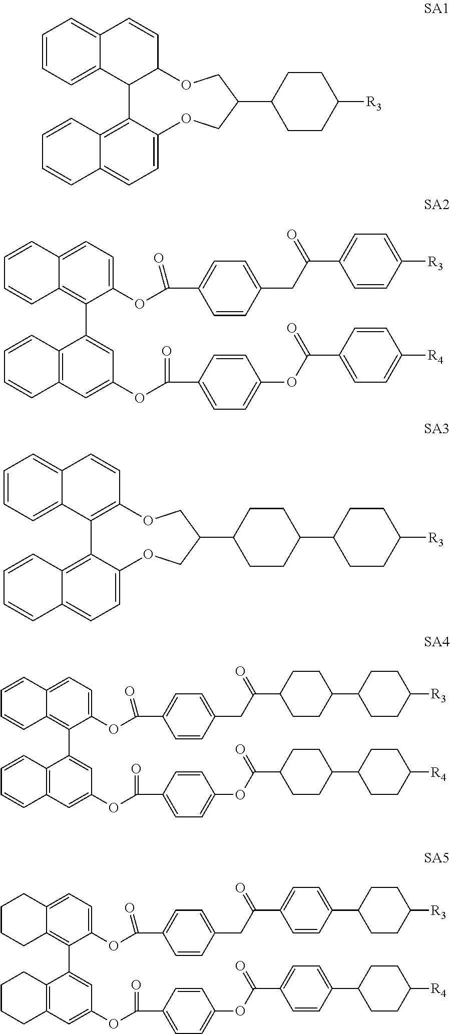

wherein
R₃ and R₄ each independently represent an alkyl group with a carbon atom number of 1-6, a fluorine-substituted alkyl group with a carbon atom number of 1-6, an alkoxy group with a carbon atom number of 1-6, a fluorine-substituted alkoxy group with a carbon atom number of 1-6, an alkenyl group with a carbon atom number of 2-6, a fluorine-substituted alkenyl group with a carbon atom number of 2-6, an alkenyloxy group with a carbon atom number of 3-8, or an fluorine-substituted alkenyloxy group with a carbon atom number of 3-8.

The cholesteric liquid crystal composition of the present invention, preferably the above-mentioned cholesteric liquid crystal composition, comprises a chiral agent compound represented by formula S1-1 and at least one of chiral agent compounds represented by formulas SA1 to SA5.

In the cholesteric liquid crystal composition of the present invention, preferably the described cholesteric liquid crystal composition, the total mass of the added amount of the chiral agent compound and the liquid crystal composition is 100%.

In the cholesteric liquid crystal composition of the present invention, preferably, the mass percentage content of chiral agent compound S1-1 is 0.5-10%, and the mass percentage content of chiral agent compounds SA1 to SA5 is 0.1-5%.

In the cholesteric liquid crystal composition of the present invention, preferably, the mass percentage content of chiral agent compound S1-1 is 2-6%, and the mass percentage content of chiral agent compounds SA1 to SA5 is 0.1-3%.

The present invention further provides a cholesteric liquid crystal display element comprising the cholesteric liquid crystal composition of the present invention, wherein the cholesteric liquid crystal display element is an active matrix addressed display element or a passive matrix addressed display element.

The present invention further provides a cholesteric liquid crystal display comprising the cholesteric liquid crystal composition of the present invention, wherein the cholesteric liquid crystal display is an active matrix addressed display or a passive matrix addressed display.

### Beneficial Effects

The chiral agent compound provided by the present invention has the properties of high HTP value, good solubility, and short switching time, because the main structure of the chiral agent compound S of the present invention is a cinnamate and isosorbide structure. This structure has relatively high electron cloud density. A fluorine-substituted group is used at the terminal group. The introduction of the fluorine atom improves the electron cloud density, thereby enhancing the oxidation resistance and stability of the molecule and also improving the solubility. In addition, in the fluoroalkoxy group introduced in the terminal group, a lone pair of electrons on the oxygen atom can donate electrons to the benzene ring by means of a p-π conjugation effect. Although the fluorine atom tends to be electron-withdrawing due to its high electronegativity, when the fluoroalkoxy group is directly connected to the benzene ring, the conjugative effect of the oxygen atom often becomes more significant. This results in the chiral agent compound of this structure exhibiting relatively high HTP value and relatively short switching time, making it suitable for any nematic liquid crystal component. Furthermore, the cholesteric liquid crystal composition provided by the present invention has relatively high reflectance retention ratio while simultaneously achieving relatively low viscosity and relatively fast UV-induced color switching speed. Furthermore, a liquid crystal display element or liquid crystal display comprising the cholesteric liquid crystal composition of the present invention has relatively high reflectance retention ratio and less reflectance decrease during a photochromic process and simultaneously offers relatively fast response speed and relatively fast UV-induced color switching speed.

### DETAILED DESCRIPTION OF EMBODIMENTS

In order to explain the present invention more clearly, the present invention will be further explained below in conjunction with preferred examples. A person skilled in the art should understand that the following detailed description is illustrative rather than restrictive and should not limit the scope of protection of the present invention.

The present invention provides a chiral agent compound selected from the following formula S,

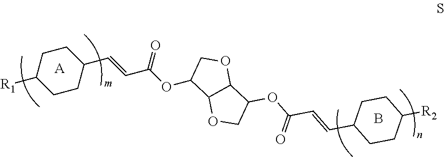

wherein
R₁ and R₂ each independently represent a fluoroalkyl group with a carbon atom number of 1-5, a fluoroalkoxy group with a carbon atom number of 1-5, a fluoroalkenyl group with a carbon atom number of 2-5, or a fluoroalkenyloxy group with a carbon atom number of 2-5;

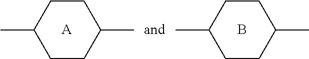

each independently represent

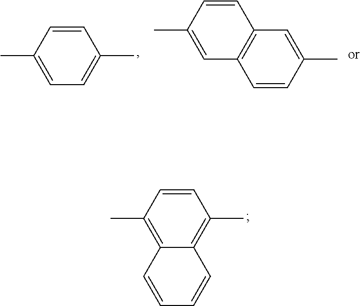

and any hydrogen of

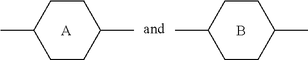

can be replaced by a halogen, an alkyl group with a carbon atom number of 1-10, an alkoxy group with a carbon atom number of 1-10, an alkenyl group with a carbon atom number of 2-10, or an alkenyloxy group with a carbon atom number of 2-10; and
m and n each independently represent 1 or 2.

The chiral agent compound of the present invention, preferably the chiral agent S is selected from the group consisting of compounds represented by the following formulas S1 to S18:

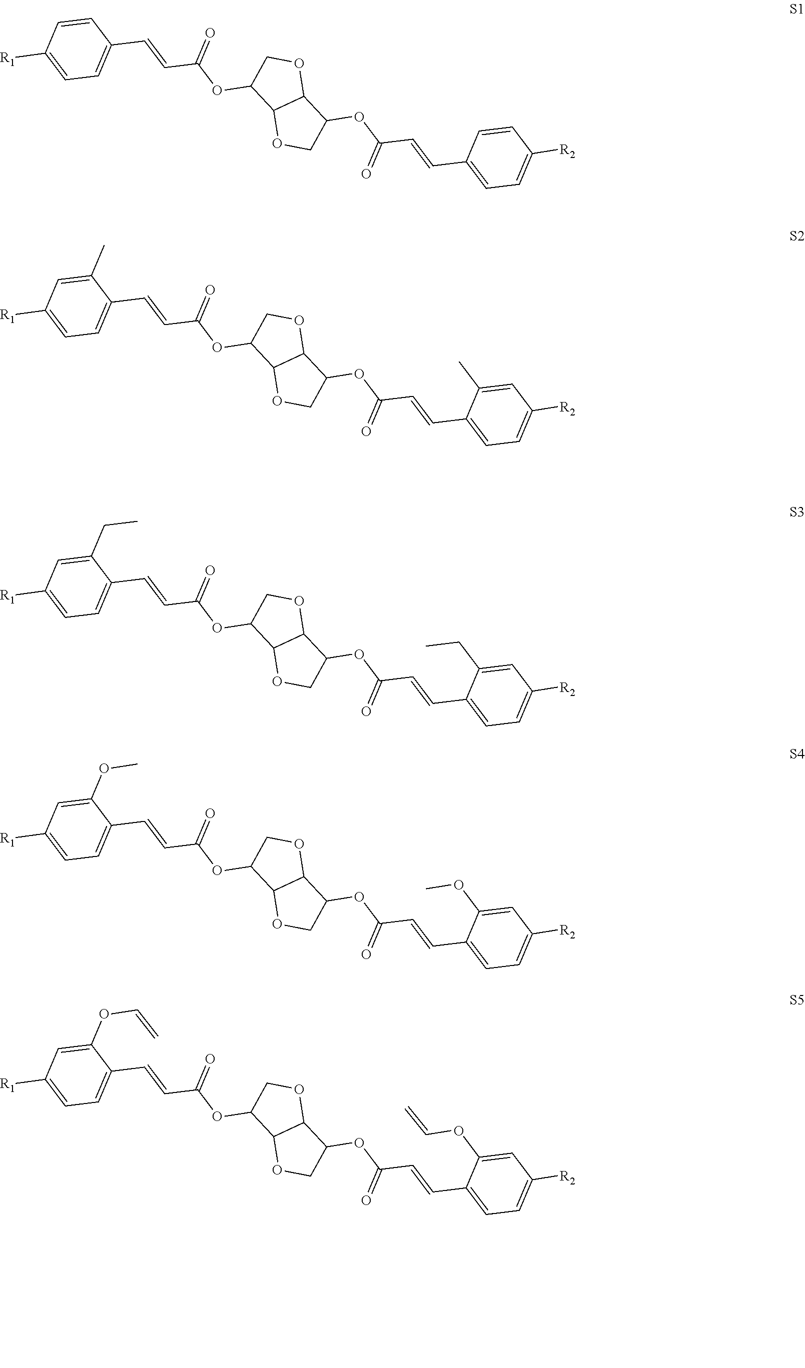

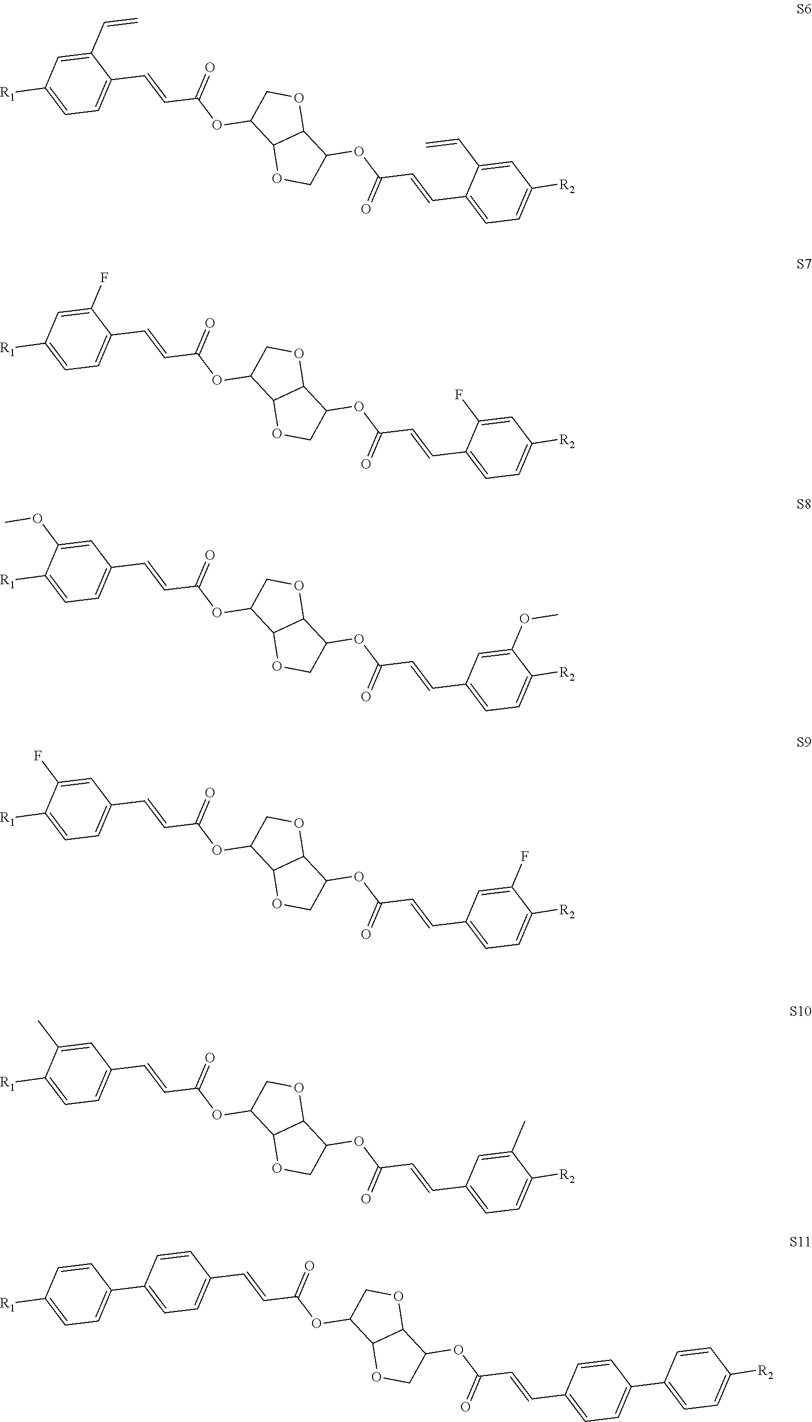

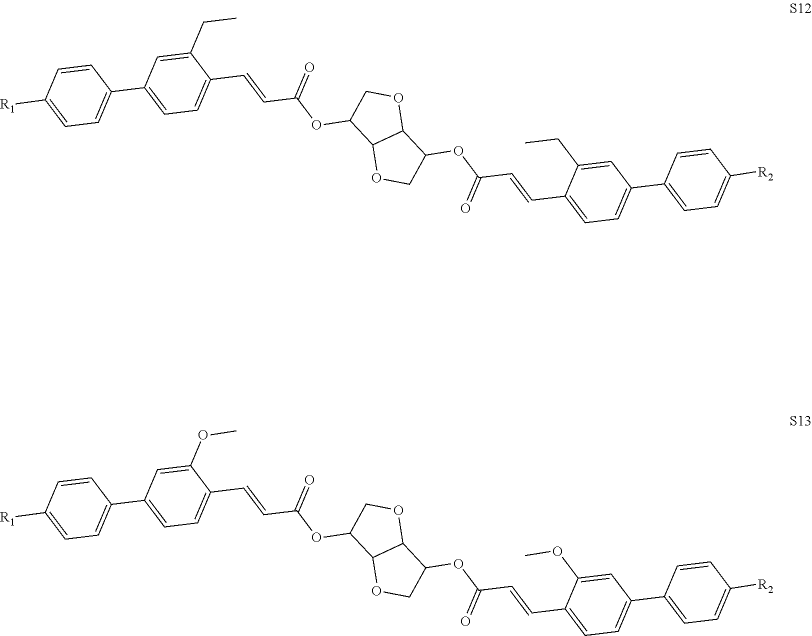

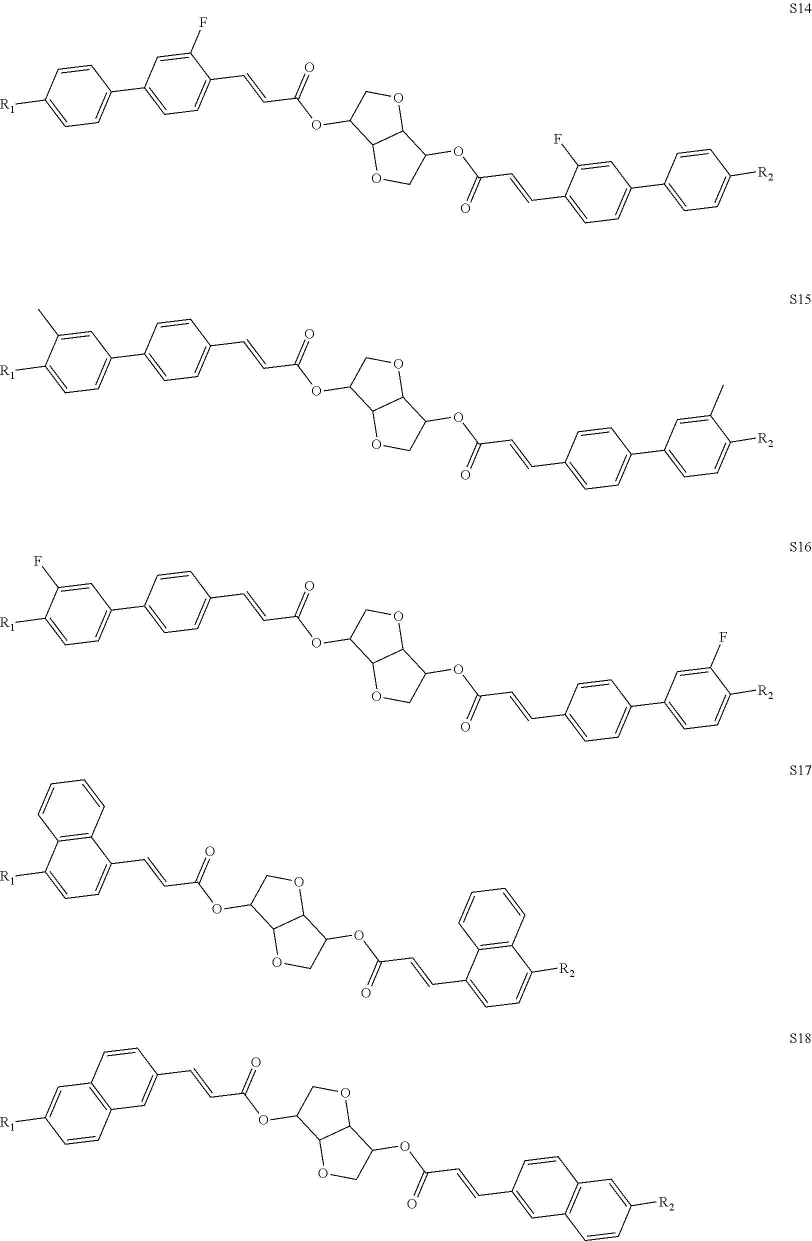

wherein
R₁ and R₂ each independently represent a fluoroalkyl group with a carbon atom number of 1-5, a fluoroalkoxy group with a carbon atom number of 1-5, a fluoroalkenyl group with a carbon atom number of 2-5, or a fluoroalkenyloxy group with a carbon atom number of 2-5.

The chiral agent compound of the present invention, preferably the chiral agents S1 to S18 are selected from the group consisting of compounds represented by the following formulas S1-1 to S18-2:

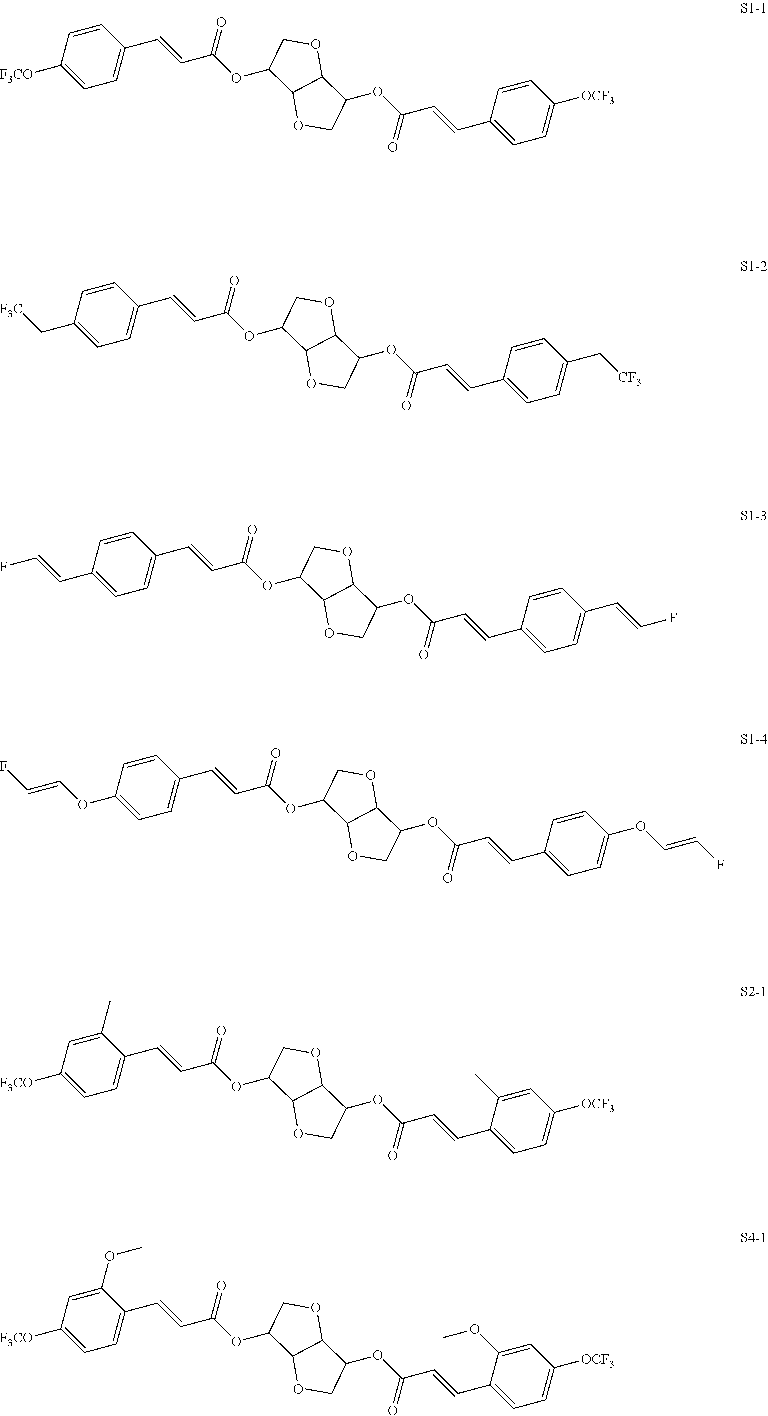 [SMILES: O=C(/C=C/c1ccc(OC(F)(F)F)cc1)OC1COC2C(OC(=O)/C=C/c3ccc(OC(F)(F)F)cc3)COC12 ; O=C(/C=C/c1ccc(CC(F)(F)F)cc1)OC1COC2C(OC(=O)/C=C/c3ccc(CC(F)(F)F)cc3)COC12 ; O=C(/C=C/c1ccc(/C=C/F)cc1)OC1COC2C(OC(=O)/C=C/c3ccc(/C=C/F)cc3)COC12 ; O=C(/C=C/c1ccc(O/C=C/F)cc1)OC1COC2C(OC(=O)/C=C/c3ccc(O/C=C/F)cc3)COC12 ; Cc1cc(OC(F)(F)F)ccc1/C=C/C(=O)OC1COC2C(OC(=O)/C=C/c3ccc(OC(F)(F)F)cc3C)COC12 ; COc1cc(OC(F)(F)F)ccc1/C=C/C(=O)OC1COC2C(OC(=O)/C=C/c3ccc(OC(F)(F)F)cc3OC)COC12]

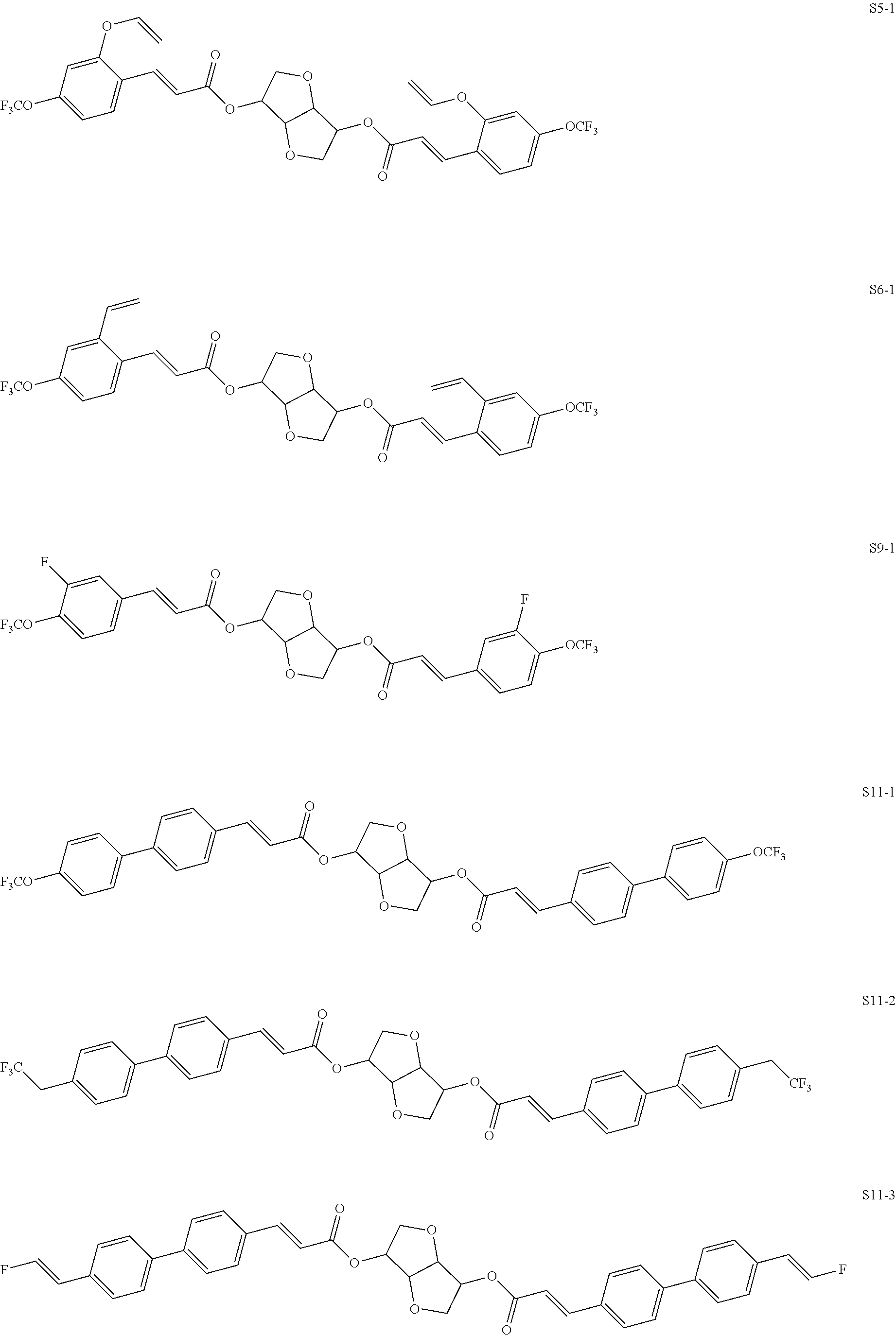

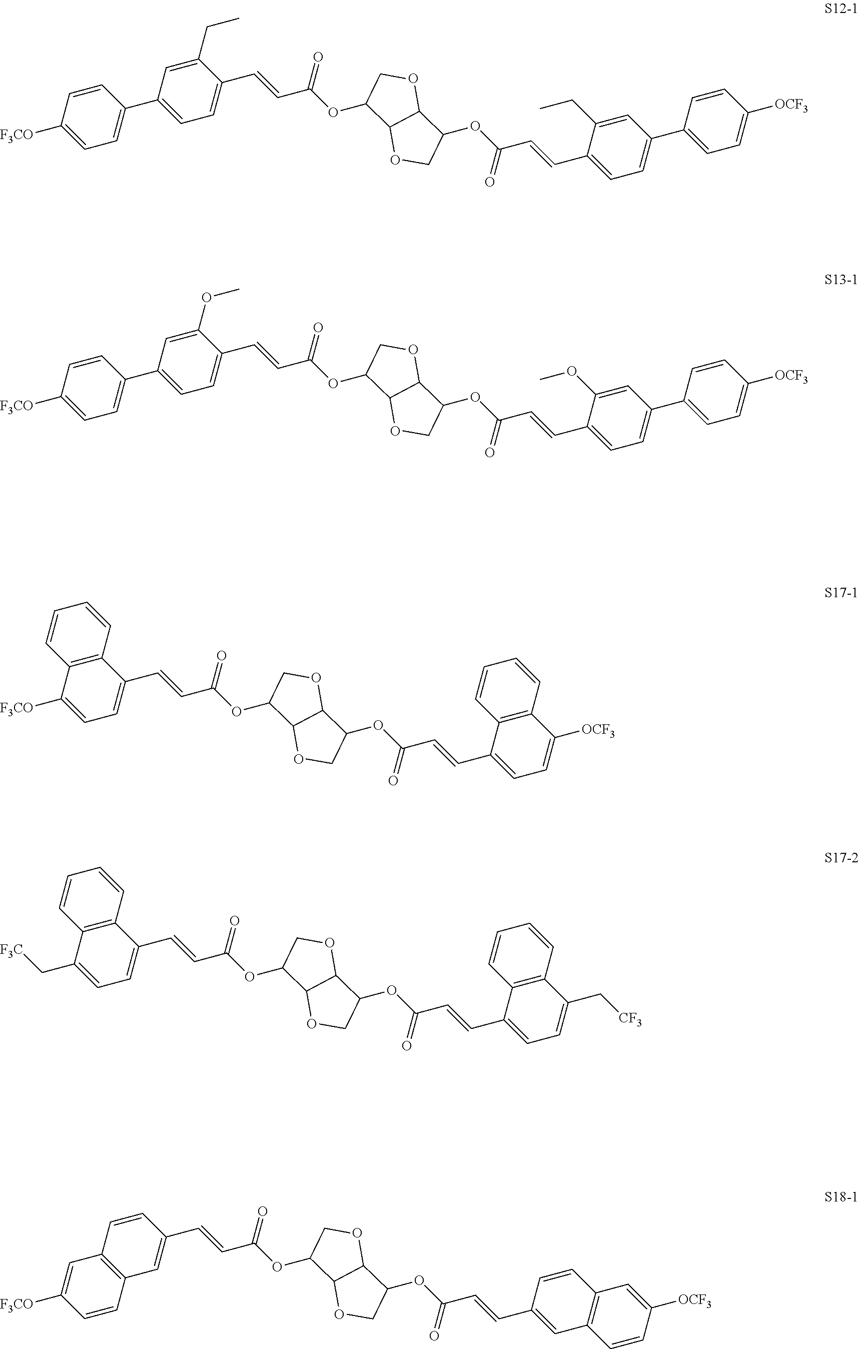 [SMILES: CCc1cc(-c2ccc(OC(F)(F)F)cc2)ccc1/C=C/C(=O)OC1COC2C(OC(=O)/C=C/c3ccc(-c4ccc(OC(F)(F)F)cc4)cc3CC)COC12 ; COc1cc(-c2ccc(OC(F)(F)F)cc2)ccc1/C=C/C(=O)OC1COC2C(OC(=O)/C=C/c3ccc(-c4ccc(OC(F)(F)F)cc4)cc3OC)COC12 ; O=C(/C=C/c1ccc(OC(F)(F)F)c2ccccc12)OC1COC2C(OC(=O)/C=C/c3ccc(OC(F)(F)F)c4ccccc34)COC12 ; O=C(/C=C/c1ccc(CC(F)(F)F)c2ccccc12)OC1COC2C(OC(=O)/C=C/c3ccc(CC(F)(F)F)c4ccccc34)COC12 ; O=C(/C=C/c1ccc2cc(OC(F)(F)F)ccc2c1)OC1COC2C(OC(=O)/C=C/c3ccc4cc(OC(F)(F)F)ccc4c3)COC12]

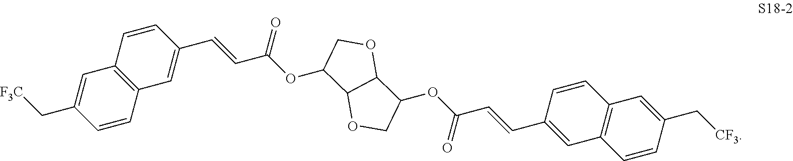 [SMILES: O=C(/C=C/c1ccc2cc(CC(F)(F)F)ccc2c1)OC1COC2C(OC(=O)/C=C/c3ccc4cc(CC(F)(F)F)ccc4c3)COC12]

Furthermore, the present invention provides a cholesteric liquid crystal composition, preferably the above-mentioned cholesteric liquid crystal composition, comprising one or more chiral agent compounds selected from chiral agent compounds represented by formula S.

The cholesteric liquid crystal composition of the present invention, preferably the above-mentioned cholesteric liquid crystal composition, at least comprises a chiral agent compound represented by formula S1-1.

The cholesteric liquid crystal composition of the present invention, preferably the above-mentioned cholesteric liquid crystal composition, further comprises one or more of chiral agent compounds represented by formulas SA1 to SA5,

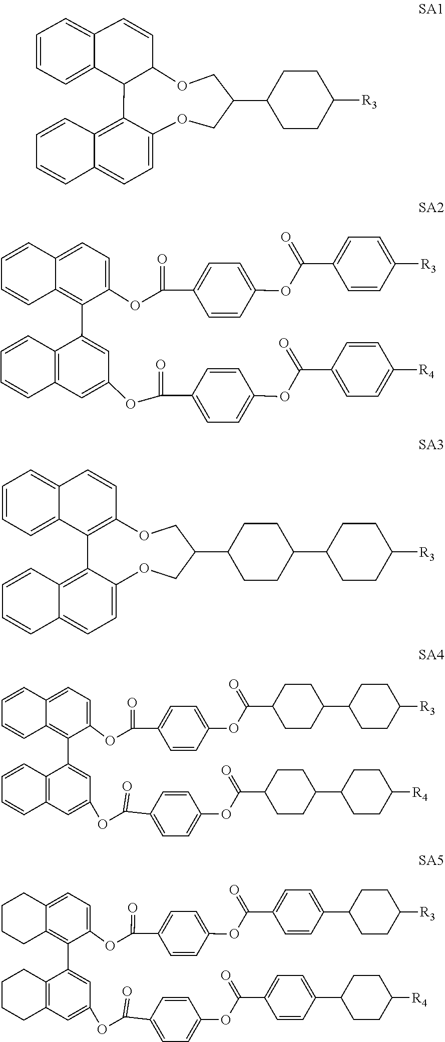

wherein
R₃ and R₄ each independently represent an alkyl group with a carbon atom number of 1-6, a fluorine-substituted alkyl group with a carbon atom number of 1-6, an alkoxy group with a carbon atom number of 1-6, a fluorine-substituted alkoxy group with a carbon atom number of 1-6, an alkenyl group with a carbon atom number of 2-6, a fluorine-substituted alkenyl group with a carbon atom number of 2-6, an alkenyloxy group with a carbon atom number of 3-8, or an fluorine-substituted alkenyloxy group with a carbon atom number of 3-8.

The cholesteric liquid crystal composition of the present invention, preferably the above-mentioned cholesteric liquid crystal composition, comprises a chiral agent compound represented by formula S1-1 and at least one of chiral agent compounds represented by formulas SA1 to SA5.

In the cholesteric liquid crystal composition of the present invention, preferably, on the basis of the total mass of the chiral agent compound and the nematic liquid crystal component being 100%, the mass percentage content of chiral agent compound S1-1 is 0.5-10%, and the mass percentage content of chiral agent compounds SA1 to SA5 is 0.1-5%.

In the cholesteric liquid crystal composition of the present invention, preferably, the mass percentage content of chiral agent compound S1-1 is 2-6%, and the mass percentage content of chiral agent compounds SA1 to SA5 is 0.1-3%.

The cholesteric liquid crystal composition of the present invention preferably further comprises a chiral agent compound represented by formula SA6,

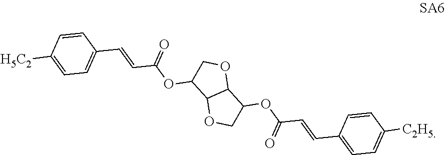

The cholesteric liquid crystal composition of the present invention preferably comprises a chiral agent compound represented by formula S1-1, at least one chiral agent compound selected from chiral agent compounds represented by formulas SA1 to SA5, and a chiral agent compound represented by formula SA6.

In the cholesteric liquid crystal composition of the present invention, preferably, the mass percentage content of chiral agent compound S1-1 is 2-6%, the mass percentage content of chiral agent compounds SA1 to SA5 is 0.1-3%, and the mass percentage content of chiral agent compound SA6 is 0.1-3%.

The cholesteric liquid crystal composition of the present invention, preferably the above-mentioned cholesteric liquid crystal composition, further comprises a nematic liquid crystal component composed of one or more compounds represented by formula I, one or more compounds represented by formula II, one or more compounds represented by formula III, and one or more compounds represented by formula IV,

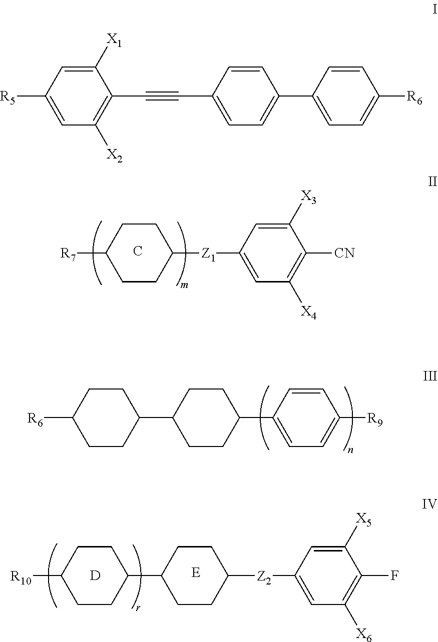

wherein
R₅, R₆, R₉, and R₁₀ each independently represent an alkyl group with a carbon atom number of 1-10; and one or more non-adjacent —CH₂— in R₁₀ can be replaced by cyclopentylene or cyclopropylene;
R₇ represents an alkyl group with a carbon atom number of 1-10 or an alkenyl group with a carbon atom number of 2-10;
R₈ represents an alkenyl group with a carbon atom number of 2-10;
X₁, X₂, X₃, X₄, X₅, and X₆ each independently represent H or F;
m represents 1, 2, or 3;
n represents 0 or 1;
r represents 0, 1, or 2;
Z₁ represents a single bond, —COO—, or —OCO—;
Z₂ represents a single bond, —COO—, —OCO—, —OCF₂—, or —CF₂O—; and

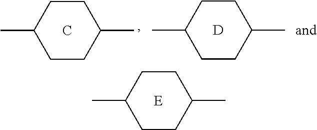

each independently represent

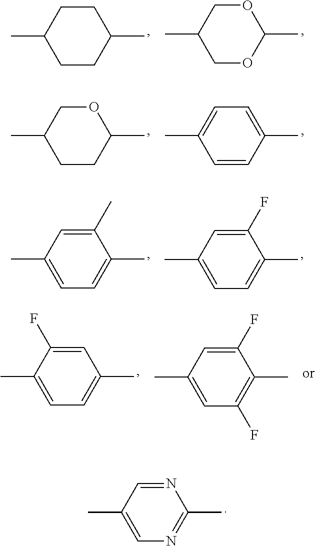

In the cholesteric liquid crystal composition of the present invention, preferably, the above-mentioned compound represented by formula I is selected from the group consisting of compounds represented by the following formulas I1 to I3,

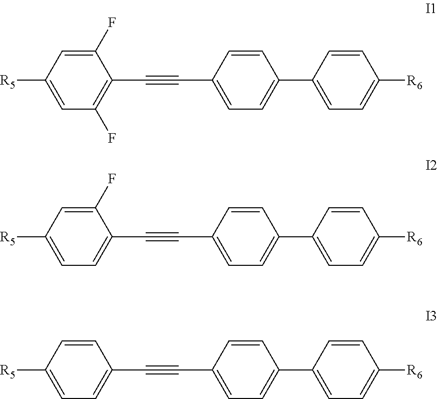

wherein
R₅ and R₆ each independently represent an alkyl group with a carbon atom number of 1-10.

In the cholesteric liquid crystal composition of the present invention, preferably, the above-mentioned compound represented by formula II is selected from the group consisting of compounds represented by the following formulas II1 to II7,

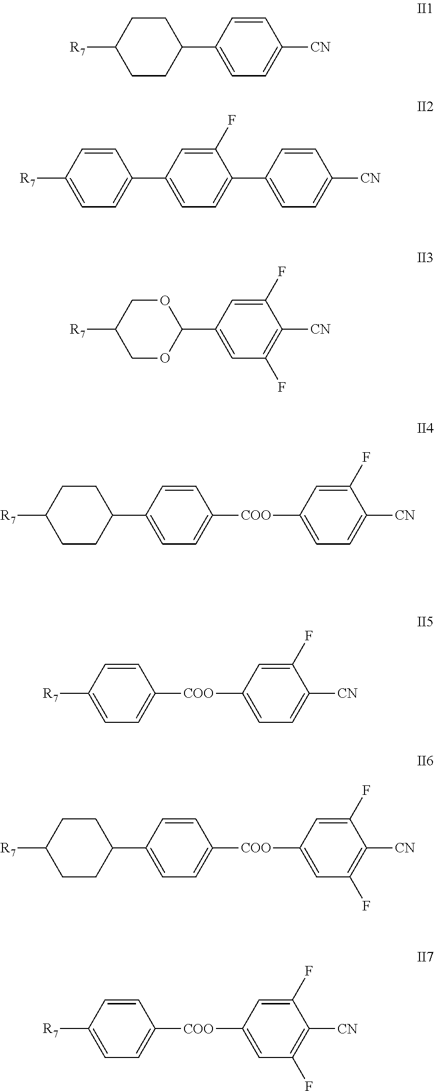

wherein
R₇ represents an alkyl group with a carbon atom number of 1-10 or an alkenyl group with a carbon atom number of 2-10.

In the cholesteric liquid crystal composition of the present invention, preferably, the above-mentioned compound represented by formula III is selected from the group consisting of compounds represented by the following formulas III1 to III2,

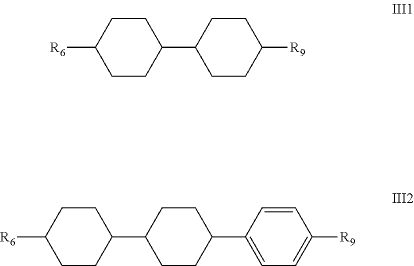

wherein
R₈ represents an alkenyl group with a carbon atom number of 2-10;
R₉ represents an alkyl group with a carbon atom number of 1-10.

In the cholesteric liquid crystal composition of the present invention, preferably, the above-mentioned compound represented by formula IV is selected from the group consisting of compounds represented by the following formulas IVI to IV13,

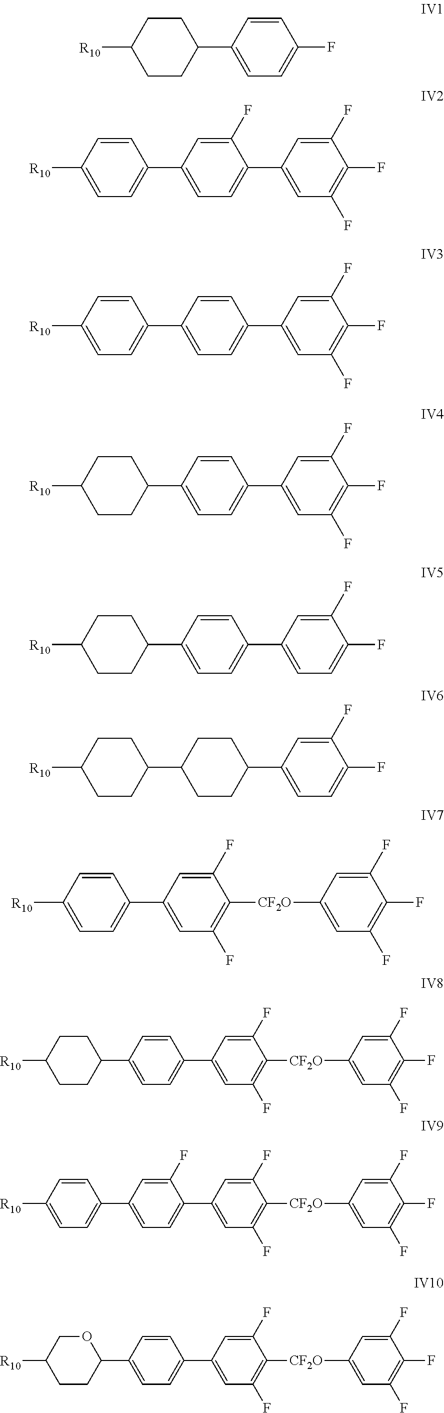

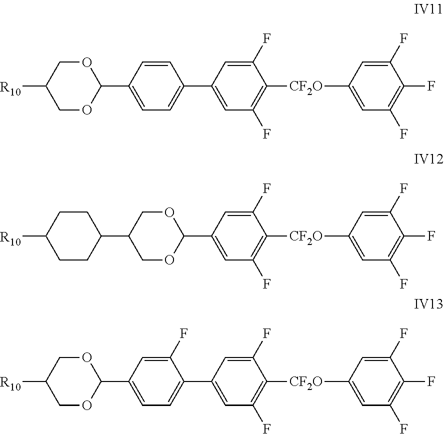

wherein
R₁₀ represents an alkyl group with a carbon atom number of 1-10; and one or more non-adjacent —CH₂— in R₁₀ can be replaced by cyclopentylene or cyclopropylene.

In the cholesteric liquid crystal composition of the present invention, preferably, in the nematic liquid crystal component, the mass percentage content of the compound represented by formula I, the compound represented by formula II, the compound represented by formula III, and the compound represented by formula IV can be in any ratio according to actual needs.

The cholesteric liquid crystal composition of the present invention, preferably the above-mentioned cholesteric liquid crystal composition, further comprises one or more compounds represented by formula V,

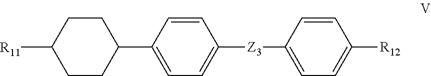

wherein
R₁₁ and R₁₂ each independently represent an alkyl group with a carbon atom number of 1-10; and
Z₃ represents a single bond or —C≡C—.

In the cholesteric liquid crystal composition of the present invention, preferably, the above-mentioned compound represented by formula V is selected from the group consisting of compounds represented by the following formulas V1 to V2,

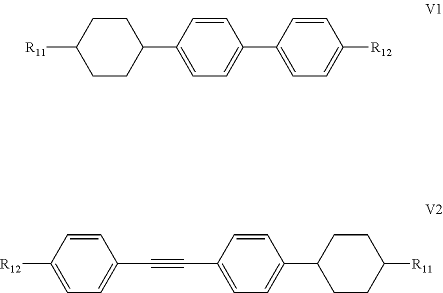

wherein
R₁₁ and R₁₂ each independently represent an alkyl group with a carbon atom number of 1-10.

In the cholesteric liquid crystal composition of the present invention, preferably, in the nematic liquid crystal component, the mass percentage content of the compound represented by formula I, the compound represented by formula II, the compound represented by formula III, and the compound represented by formula IV, and the compound represented by formula V can be in any ratio according to actual needs.

A variety of functional dopants may also be added to the cholesteric liquid crystal compound of the present invention, and the content of the dopant is preferably between 0.01% and 1%. The dopants may include, by way of example, an antioxidant and an ultraviolet absorber.

The antioxidant may include, by way of example,

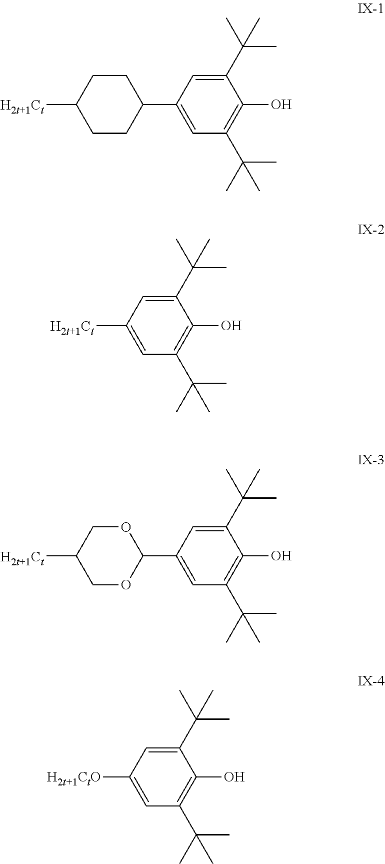

wherein t represents an integer of 1-10.

The light stabilizer may include, by way of example,

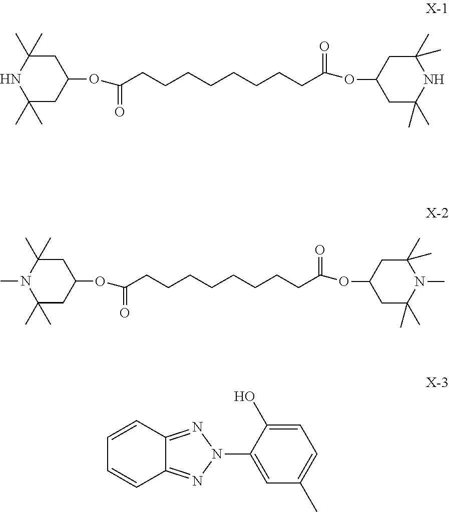

### [Liquid Crystal Display Element or Liquid Crystal Display]

The present invention further relates to a liquid crystal display element or liquid crystal display comprising any one of the above-mentioned cholesteric liquid crystal compositions; and the display element or display is an active matrix display element or display or a passive matrix display element or display.

The cholesteric liquid crystal display element or cholesteric liquid crystal display of the present invention is preferably an active matrix addressed liquid crystal display element or liquid crystal display.

A liquid crystal display element or liquid crystal display comprising the cholesteric liquid crystal composition of the present invention has relatively high reflectance retention ratio and less reflectance decrease during a photochromic process and simultaneously offers relatively fast response speed and relatively fast UV-induced color switching speed.

### EXAMPLES

In order to explain the present invention more clearly, the present invention will be further explained below with reference to examples. A person skilled in the art should understand that the following detailed description is illustrative rather than restrictive and should not limit the scope of protection of the present invention.

### Synthesis Examples

### Synthesis Example 1 Preparation of Liquid Crystal Compound S1-1

The preparation route was as follows:

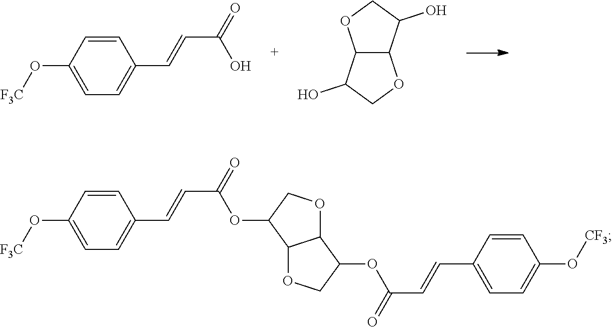 [SMILES: O=C(O)/C=C/c1ccc(OC(F)(F)F)cc1 ; OC1COC2C(O)COC12 ; O=C(/C=C/c1ccc(OC(F)(F)F)cc1)OC1COC2C(OC(=O)/C=C/c3ccc(OC(F)(F)F)cc3)COC12]

Specific operation flow of preparation:

100 g (0.429 mol) of compound

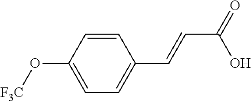 [SMILES: O=C(O)/C=C/c1ccc(OC(F)(F)F)cc1]

and 28.6 g (0.195 mol) of compound

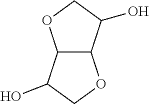

were dissolved in 1 L of dichloromethane, and 50 g (0.494 mol) of triethylamine and 4.8 g (0.039 mol) of DMAP were added. The mixture was cooled to 0° C., and 94.6 g (0.493 mol) of EDCI was added under stirring. After the addition was complete, the mixture was reacted at room temperature overnight. 500 ml of water was added to the reaction liquid. After extraction and phase separation, the aqueous phase was extracted with 2×250 ml of dichloromethane. The organic phases were combined, washed with 300 ml of a saturated aqueous sodium chloride solution, dried, and concentrated. 200 ml of anhydrous ethanol and 200 ml of petroleum ether were added at room temperature for recrystallization. This was repeated once to obtain 62.5 g of S1-1 as a white solid, with a yield of 56%.

### Synthesis Example 2 Preparation of Liquid Crystal Compound S1-2

The preparation route was as follows:

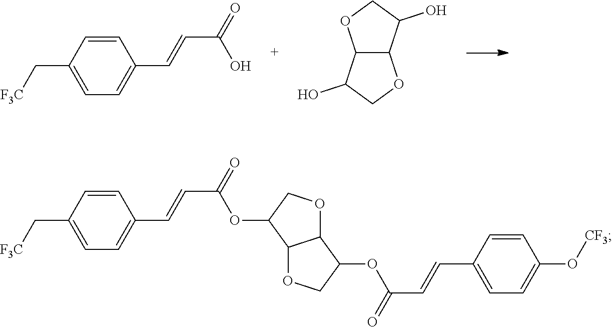 [SMILES: O=C(O)/C=C/c1ccc(CC(F)(F)F)cc1 ; OC1COC2C(O)COC12 ; O=C(/C=C/c1ccc(CC(F)(F)F)cc1)OC1COC2C(OC(=O)/C=C/c3ccc(OC(F)(F)F)cc3)COC12]

Specific operation flow of preparation:

98.4 g (0.429 mol) of compound

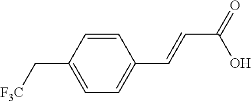 [SMILES: O=C(O)/C=C/c1ccc(CC(F)(F)F)cc1]

and 28.6 g (0.195 mol) of compound

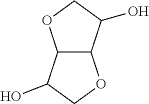

were dissolved in 1 L of dichloromethane, and 50 g (0.494 mol) of triethylamine and 4.8 g (0.039 mol) of DMAP were added. The mixture was cooled to 0° C., and 94.6 g (0.494 mol) of EDCI was added under stirring. After the addition was complete, the mixture was reacted at room temperature overnight. 500 ml of water was added to the reaction liquid. After extraction and phase separation, The aqueous phase was extracted with 2×250 ml of dichloromethane. The organic phases were combined, washed with 300 ml of a saturated aqueous sodium chloride solution, dried, and concentrated. 200 ml of anhydrous ethanol and 200 ml of petroleum ether were added at room temperature for recrystallization. This was repeated once to obtain 49.8 g of S1-2 as a white solid, with a yield of 45%.

### Synthesis Example 3 Preparation of Liquid Crystal Compound S11-1

The preparation route was as follows:

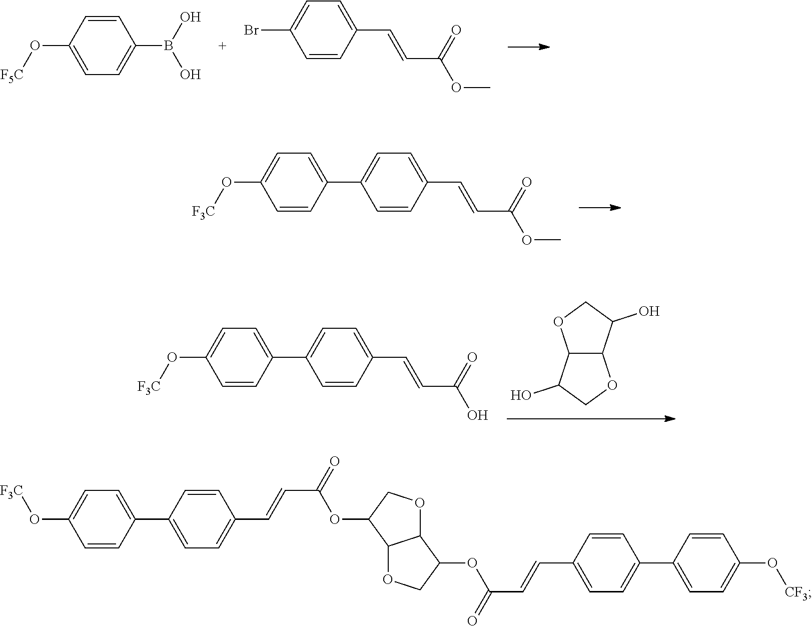

Specific operation flow of preparation:

51.9 g (0.252 mol) of compound

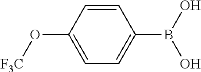 [SMILES: OB(O)c1ccc(OC(F)(F)F)cc1]

and 55.2 g (0.229 mol) of compound

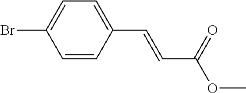

were dissolved in a mixed solution of 500 ml of toluene and 100 ml of water. 47.5 g (0.343 mol) of potassium carbonate and Pd-132 were added. After nitrogen displacement, the mixture was reacted under reflux for 2 hours. After cooling, 200 ml of water and 300 ml of toluene were added. After extraction and phase separation, the aqueous phase was extracted with 2×200 ml of toluene. The organic phases were combined, washed with 300 ml of a saturated aqueous sodium chloride solution, dried, and concentrated to obtain 73.8 g of compound

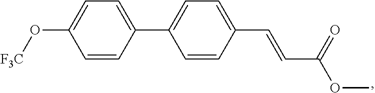 [SMILES: COC(=O)/C=C/c1ccc(-c2ccc(OC(F)(F)F)cc2)cc1]

with a yield of 100%.

73.8 g (0.229 mol) of compound

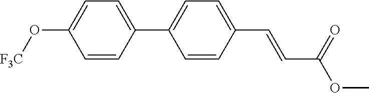 [SMILES: COC(=O)/C=C/c1ccc(-c2ccc(OC(F)(F)F)cc2)cc1]

and 11 g (0.274 mol) of sodium hydroxide were dissolved in a mixed solution of 700 ml of THF and 700 ml of water and reacted under reflux for 4 hours. After cooling to room temperature, the organic phase was concentrated, and the aqueous phase was extracted with 500 ml of ethyl acetate twice. Phase separation was carried out, and hydrochloric acid was added to the aqueous phase to adjust the pH to acidity. After suction filtration, the filter cake was washed with water. The filter cake was dissolved by adding 500 mL of ethyl acetate and washed with 1×200 mL of brine. After phase separation, the organic phase was dried and concentrated to obtain 65 g of compound

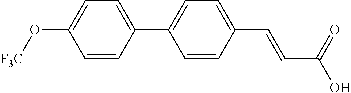 [SMILES: O=C(O)/C=C/c1ccc(-c2ccc(OC(F)(F)F)cc2)cc1]

with a yield of 92%.

65 g (0.214 mol) of compound

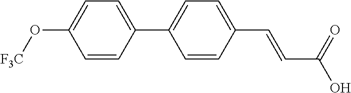 [SMILES: O=C(O)/C=C/c1ccc(-c2ccc(OC(F)(F)F)cc2)cc1]

and 14.3 g (0.097 mol) of compound

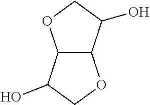

were dissolved in 500 ml of dichloromethane, and 25 g (0.244 mol) of triethylamine and 2.4 g (0.0195 mol) of DMAP were added. The mixture was cooled to 0° C., and 46.8 g (0.244 mol) of EDCI was added under stirring. After the addition was complete, the mixture was reacted at room temperature overnight. 250 ml of water was added to the reaction liquid. After extraction and phase separation, The aqueous phase was extracted with 2×100 ml of dichloromethane. The organic phases were combined, washed with 300 ml of a saturated aqueous sodium chloride solution, dried, and concentrated. Separation and purification were carried out by column chromatography to obtain 24.8 g of S11-1 as a white solid with a yield of 35%.

### Synthesis Example 4 Preparation of Liquid Crystal Compound S11-2

The preparation route was as follows:

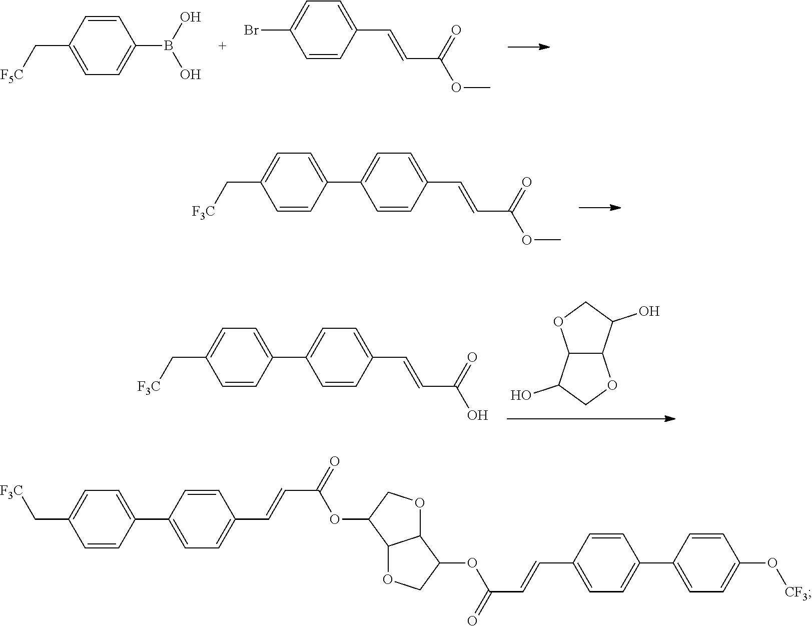

Specific operation flow of preparation:

54.9 g (0.269 mol) of compound

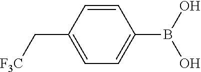 [SMILES: OB(O)c1ccc(CC(F)(F)F)cc1]

and 59 g (0.245 mol) of compound

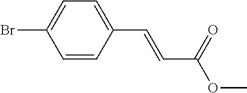

were dissolved in a mixed solution of 500 ml of toluene and 100 ml of water. 50.8 g (0.367 mol) of potassium carbonate and Pd-132 were added. After nitrogen displacement, the mixture was reacted under reflux for 2 hours. After cooling, 200 ml of water and 300 ml of toluene were added. After extraction and phase separation, the aqueous phase was extracted with 2×200 ml of toluene. The organic phases were combined, washed with 300 ml of a saturated aqueous sodium chloride solution, dried, and concentrated to obtain 72.1 g of compound

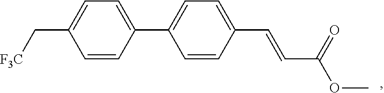 [SMILES: COC(=O)/C=C/c1ccc(-c2ccc(CC(F)(F)F)cc2)cc1]

with a yield of 92%.

72.1 g (0.225 mol) of compound

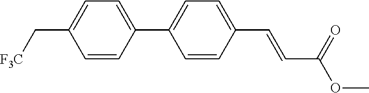 [SMILES: COC(=O)/C=C/c1ccc(-c2ccc(CC(F)(F)F)cc2)cc1]

and 11 g (0.27 mol) of sodium hydroxide were dissolved in a mixed solution of 700 ml of THF and 700 ml of water and reacted under reflux for 4 hours. After cooling to room temperature, the organic phase was concentrated, and the aqueous phase was extracted with 500 ml of ethyl acetate twice. Phase separation was carried out, and hydrochloric acid was added to the aqueous phase to adjust the pH to acidity. After suction filtration, the filter cake was washed with water. The filter cake was dissolved by adding 500 mL of ethyl acetate and washed with 1×200 mL of brine. After phase separation, the organic phase was dried and concentrated to obtain 65.5 g of compound

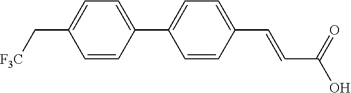 [SMILES: O=C(O)/C=C/c1ccc(-c2ccc(CC(F)(F)F)cc2)cc1]

with a yield of 95%.

65.5 g (0.214 mol) of compound

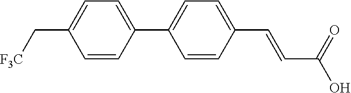 [SMILES: O=C(O)/C=C/c1ccc(-c2ccc(CC(F)(F)F)cc2)cc1]

and 14.3 g (0.097 mol) of compound

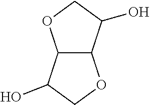

were dissolved in 500 ml of dichloromethane, and 25 g (0.244 mol) of triethylamine and 2.4 g (0.0195 mol) of DMAP were added. The mixture was cooled to 0° C., and 46.8 g (0.244 mol) of EDCI was added under stirring. After the addition was complete, the mixture was reacted at room temperature overnight. 250 ml of water was added to the reaction liquid. After extraction and phase separation, The aqueous phase was extracted with 2×100 ml of dichloromethane. The organic phases were combined, washed with 300 ml of a saturated aqueous sodium chloride solution, dried, and concentrated. Separation and purification were carried out by column chromatography to obtain 33.6 g of S11-2 as a white solid with a yield of 48%.

### Synthesis Example 5 Preparation of Liquid Crystal Compound S17-1

The preparation route was as follows:

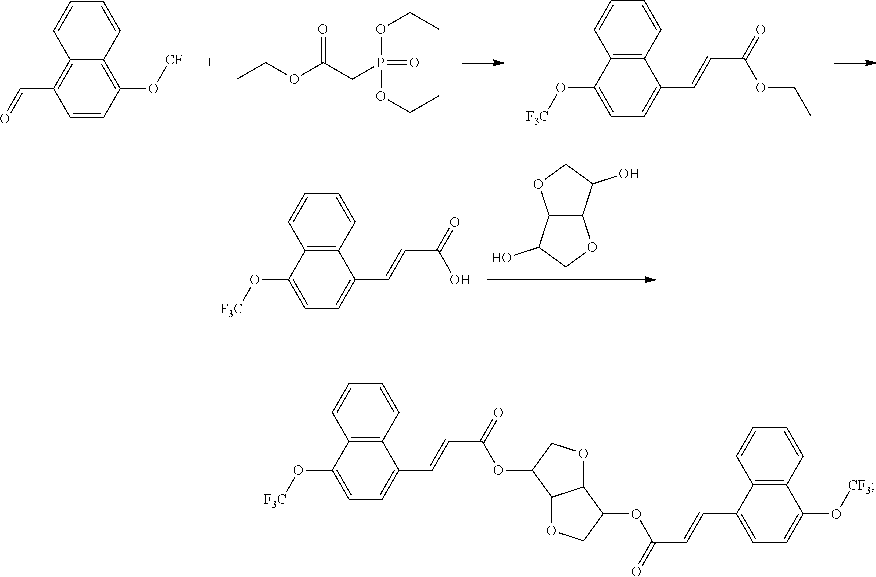

Specific operation flow of preparation:

11.3 g (0.282 mol) of sodium hydride (60%) and 150 ml of THF were added to a reaction flask. After nitrogen displacement and cooling to 0° C., 150 ml of a solution of 63.1 g (0.282 mol) of compound

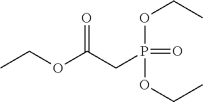

in THF was dropwise added. After the addition was complete, the mixture was controlled at a temperature of 0° C. and stirred for 1 hour, and 300 ml of a solution of 61.5 g (0.256 mol) of compound

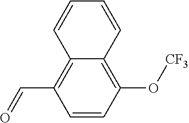 [SMILES: O=Cc1ccc(OC(F)(F)F)c2ccccc12]

in THF was dropwise added. After the addition was complete, the mixture was reacted at room temperature for 2 hours. The reaction was quenched by adding 400 ml of an aqueous NaHCO₃ solution. 600 ml of ethyl acetate was added for extraction and phase separation. The aqueous phase was extracted with 2×200 mL of ethyl acetate. The organic phases were combined and washed with 2×100 mL of brine. After phase separation, the organic phase was dried and concentrated to obtain 70.6 g of compound

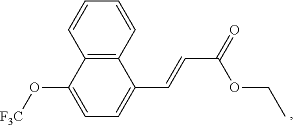 [SMILES: CCOC(=O)/C=C/c1ccc(OC(F)(F)F)c2ccccc12]

with a yield of 89%.

70.6 g (0.228 mol) of compound

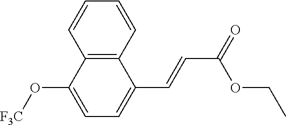 [SMILES: CCOC(=O)/C=C/c1ccc(OC(F)(F)F)c2ccccc12]

and 11 g (0.274 mol) of sodium hydroxide were dissolved in a mixed solution of 700 ml of THF and 700 ml of water and reacted under reflux for 4 hours. After cooling to room temperature, the organic phase was concentrated, and the aqueous phase was extracted with 500 ml of ethyl acetate twice. Phase separation was carried out, and hydrochloric acid was added to the aqueous phase to adjust the pH to acidity. After suction filtration, the filter cake was washed with water. The filter cake was dissolved by adding 500 mL of ethyl acetate and washed with 1×200 mL of brine. After phase separation, the organic phase was dried and concentrated to obtain 60.4 g of compound

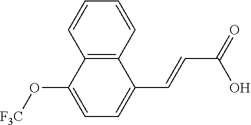 [SMILES: O=C(O)/C=C/c1ccc(OC(F)(F)F)c2ccccc12]

with a yield of 93.8%.

60.4 g (0.214 mol) of compound

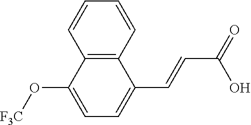 [SMILES: O=C(O)/C=C/c1ccc(OC(F)(F)F)c2ccccc12]

and 14.3 g (0.097 mol) of compound

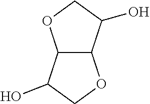

were dissolved in 500 ml of dichloromethane, and 25 g (0.244 mol) of triethylamine and 2.4 g (0.0195 mol) of DMAP were added. The mixture was cooled to 0° C., and 46.8 g (0.244 mol) of EDCI was added under stirring. After the addition was complete, the mixture was reacted at room temperature overnight. 250 ml of water was added to the reaction liquid. After extraction and phase separation, The aqueous phase was extracted with 2×100 ml of dichloromethane. The organic phases were combined, washed with 300 ml of a saturated aqueous sodium chloride solution, dried, and concentrated. 200 ml of anhydrous ethanol and 200 ml of petroleum ether were added at room temperature for recrystallization. This was repeated once to obtain 32.7 g of S17-1 as a white solid, with a yield of 50%.

### Synthesis Example 6 Preparation of Liquid Crystal Compound S18-1

The preparation route was as follows:

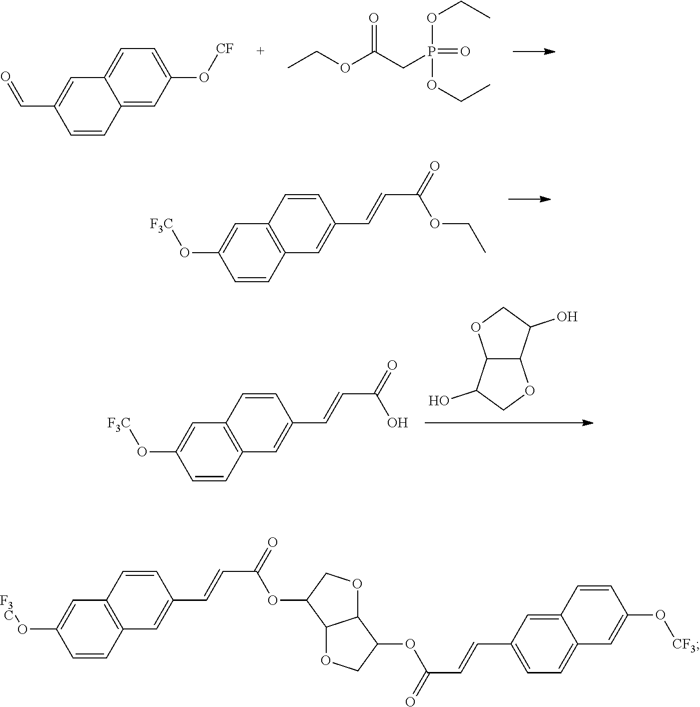

Specific operation flow of preparation:

10.2 g (0.254 mol) of sodium hydride (60%) and 150 ml of THF were added to a reaction flask. After nitrogen displacement and cooling to 0° C., 150 ml of a solution of 56.9 g (0.254 mol) of compound

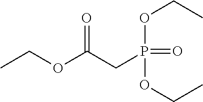

in THF was dropwise added. After the addition was complete, the mixture was controlled at a temperature of 0° C. and stirred for 1 hour, and 300 ml of a solution of 55.5 g (0.231 mol) of compound

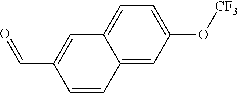 [SMILES: O=Cc1ccc2cc(OC(F)(F)F)ccc2c1]

in THF was dropwise added. After the addition was complete, the mixture was reacted at room temperature for 2 hours. The reaction was quenched by adding 400 ml of an aqueous NaHCO₃ solution. 600 ml of ethyl acetate was added for extraction and phase separation. The aqueous phase was extracted with 2×200 mL of ethyl acetate. The organic phases were combined and washed with 2×100 mL of brine. After phase separation, the organic phase was dried and concentrated to obtain 68.8 g of compound

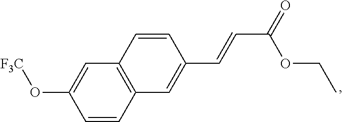 [SMILES: CCOC(=O)/C=C/c1ccc2cc(OC(F)(F)F)ccc2c1]

with a yield of 96%.

68.8 g (0.222 mol) of compound

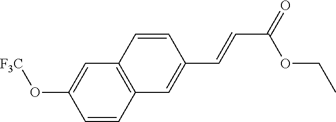 [SMILES: CCOC(=O)/C=C/c1ccc2cc(OC(F)(F)F)ccc2c1]

and 11 g (0.267 mol) of sodium hydroxide were dissolved in a mixed solution of 700 ml of THF and 700 ml of water and reacted under reflux for 4 hours. After cooling to room temperature, the organic phase was concentrated, and the aqueous phase was extracted with 500 ml of ethyl acetate twice. Phase separation was carried out, and hydrochloric acid was added to the aqueous phase to adjust the pH to acidity. After suction filtration, the filter cake was washed with water. The filter cake was dissolved by adding 500 mL of ethyl acetate and washed with 1×200 mL of brine. After phase separation, the organic phase was dried and concentrated to obtain 60.4 g of compound

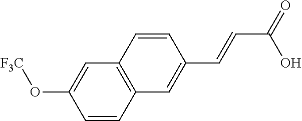 [SMILES: O=C(O)/C=C/c1ccc2cc(OC(F)(F)F)ccc2c1]

with a yield of 96%.

60.4 g (0.214 mol) of compound

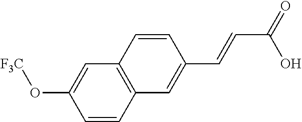 [SMILES: O=C(O)/C=C/c1ccc2cc(OC(F)(F)F)ccc2c1]

and 14.3 g (0.097 mol) of compound

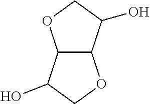

were dissolved in 500 ml of dichloromethane, and 25 g (0.244 mol) of triethylamine and 2.4 g (0.0195 mol) of DMAP were added. The mixture was cooled to 0° C., and 46.8 g (0.244 mol) of EDCI was added under stirring. After the addition was complete, the mixture was reacted at room temperature overnight. 250 ml of water was added to the reaction liquid. After extraction and phase separation, The aqueous phase was extracted with 2×100 ml of dichloromethane. The organic phases were combined, washed with 300 ml of a saturated aqueous sodium chloride solution, dried, and concentrated. 200 ml of anhydrous ethanol and 200 ml of petroleum ether were added at room temperature for recrystallization. This was repeated once to obtain 29.4 g of S18-1 as a white solid, with a yield of 45%.

Chiral agent compounds D1 to D5 used in the comparative examples are specifically as follows:

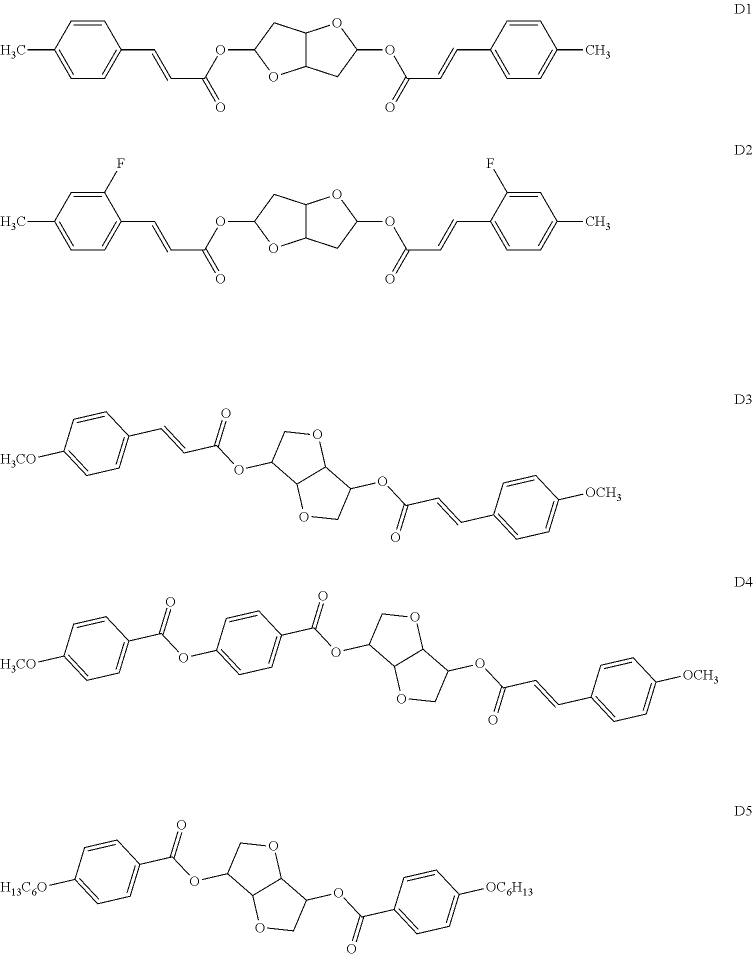

### Performance Testing Method for Chiral Agent Compound

UV-induced aging of chiral agent monomer: The chiral monomer was uniformly sprinkled on a transparent glass plate and irradiated under a 365 nm UV LED light source with an intensity of 50 mW/cm² for 1 hour.

Determination of initial and post-UV HTP values of chiral agent compound: 1% of initial or UV-aged chiral compounds S1-1, S1-2, S11-1, S11-2, S17-1, S18-1, and D1-D5 were added to a 100% host liquid crystal and mixed uniformly. The mixture was injected into a wedge-shaped liquid crystal cell (Cano cell) with a tilt angle of 1°, made of glass plates rubbed in parallel. Upon observation under a polarized optical microscope, regular Cano lines were seen. The distance l between two adjacent lines was measured, and the pitch P was determined by the formula P=2/tanθ. The helical twisting power (HTP) value can be calculated using the following formula: HTP=1/rPc, in which c is the mass concentration of the chiral additive in the host material; and r is the optical purity, often considered as 1.

Switching time(s): Chiral compounds S1-1, S1-2, S11-1, S11-2, S17-1, S18-1, and D1-D5 at various concentrations were added to host liquid crystals (Table 1). The center wavelength was adjusted to 450 nm. The cholesteric liquid crystal was infused into PI-free ITO crystal cells under capillary action and irradiated under a 365 nm UV LED light source with an intensity of 50 mW/cm² until 670 nm was reached, and the switching time was recorded.

Solubility: Chiral compounds S1-1, S1-2, S11-1, S11-2, S17-1, S18-1, and D1-D5 at different concentrations were added to host liquid crystals (Table 1) and placed in a −20° C. environment for low-temperature storage; and after 10 days, the dissolution thereof was observed, and the maximum fraction thereof at which no crystallization occurred was recorded.

The host liquid crystals are as shown in Table 1. Those listed in Table 1 are only provided for example and do not represent a special limitation on the technical solution of the present application. The specific structure and mass percentage content of each component may vary depending on the actual test requirements.

TABLE 1

| No. | Structure | Mass percentage content |
|---|---|---|
| I | UTPP-3-2 | 10 |
| I | UTPP-3-4 | 10 |
| I | UTPP-2-3 | 11 |
| I | UTPP-4-3 | 9 |
| II | PZG-2-N | 5 |
| II | PZG-4-N | 5 |
| II | PZG-3-N | 5 |
| II | PZU-V2-N | 8 |
| II | PZU-3-N | 4 |
| II | PZU-5-N | 4 |
| II | CCZU-3-N | 4 |
| II | CCZU-2-N | 3 |
| III | CC-3-V | 7 |
| IV | PUQU-3-F | 11 |
| IV | CPTP-3-2 | 4 |

The experimental data of initial HTP (μm⁻¹), post-UV HTP (μm⁻), switching time(s), and solubility are as shown in Table 2:

TABLE 2

| Chiral agent | Initial | Post-UV | Switching | |
|---|---|---|---|---|
| Compound | HTP (μm⁻¹) | HTP (μm⁻¹) | time (s) | Solubility |
| S1-1 | 45.4 | 45.1 | 120 | 7 |
| S1-2 | 40.5 | 40.2 | 140 | 6 |
| S11-1 | 54.9 | 54.6 | 100 | 1 |
| S11-2 | 58.3 | 58.1 | 110 | 0.5 |
| S17-1 | 48.4 | 48.1 | 105 | 0.2 |
| S18-1 | 50.4 | 50.1 | 108 | 0.1 |
| D1 | 42.5 | 30.8 | 125 | 5 |
| D2 | 40.1 | 25.5 | 130 | 6 |
| D3 | 45.5 | 45.1 | 300 | 4 |
| D4 | 40.5 | 40.2 | 550 | 4 |
| D5 | 50.6 | 50.1 | — | 5 |

In summary, the chiral agent compounds of the present invention have good HTP values; moreover, the performance of the chiral agent compounds after UV is stable, and the difference of HTP value before and after UV is relatively small; in addition, they also have good solubility and short switching time. Compared with the chiral agent compounds of the present invention, although the chiral agent compounds as denoted by D1 and D2 are similar to those in the present application in structure, the chiral agent compounds as denoted by D1 and D2 have relatively concentrated O atoms in the molecular structure and concentrated electron cloud density, leading to an increased activity and decreased stability of the chiral agent molecules. Especially, after UV irradiation, the chiral agent compounds D1 and D2 decomposed, resulting in decreased post-UV HTP values and even a loss of the properties of the chiral agent. Although the structure of the chiral agent compound as denoted by D3 is similar to that of the chiral agent compound of the present invention, the electron-donating ability of the alkyl group or alkoxy group is weaker than that of the fluoroalkyl group or fluoroalkoxy group, so that the electron cloud density on the benzene ring is reduced, resulting the switching time of the chiral agent molecules being short. The electron-donating ability of the alkyl group or alkoxy group as the terminal group in the chiral agent compound as denoted by D4 is weaker than that of the fluoroalkyl group or fluoroalkoxy group, so that the electron cloud density on the benzene ring is reduced; in addition, the chiral agent compound as denoted by D4 has an asymmetric structure, resulting the switching time of the chiral agent molecules being relatively short. The chiral agent compound as denoted by D5 does not contain an olefinic ester linkage, which leads to a loss of the function of the photosensitive chiral agent, and the switching time is too long to be tested.

### Performance Test Method for Compositions and Examples

In the present invention, the preparation methods are all conventional methods unless otherwise specified, the raw materials used can all be obtained from open commercial channels unless otherwise specified, the percentages all refer to mass percentages, the temperatures are in degrees Celsius (° C.), and the specific meanings of the other symbols and the test conditions are as follows:

Cp represents the clearing point (° C.) of a liquid crystal, as measured by DSC quantitative method.

S-N represents the melting point (° C.) of a liquid crystal from the crystalline phase to the nematic phase.

Δn represents optical anisotropy, no is the refractive index of ordinary light, ne is the refractive index of extraordinary light, and the test conditions are 25° C.±2° C., 589 nm, and Abbe refractometer test.

Δε represents dielectric anisotropy, Δε=ε_{//}−ε_{⊥}, wherein ε_{//} is the dielectric constant parallel to the molecular axis, and ε_{⊥} is the dielectric constant perpendicular to the molecular axis, and the test conditions are 25° C.±0.5° C., 20 μm vertical cell, and INSTEC:ALCT-IR1 test.

Method for testing the reflectance retention ratio of the cholesteric liquid crystal: The reflectance of a sample in the planar state at a wavelength of 450 nm was tested using Minolta CM-2600d colorimeter; after being driven, the sample piece was left to stand for 5 min before further testing, and the sample was then irradiated under UV until 670 nm was reached; and the above steps were repeated to test the reflectance in the planar state. Reflectance retention ratio=670 nm reflectance of sample in the planar state/450 nm reflectance of sample in the planar state.

Reflection wavelength test: The cholesteric liquid crystal was infused into PI-free ITO liquid crystal cells under capillary action, and the reflection wavelength was then tested using a liquid crystal comprehensive tester (DMS).

Test for reflection wavelength change over different UV times: The cholesteric liquid crystal was infused into PI-free ITO liquid crystal cells under capillary action and irradiated under a 365 nm UV LED light source with an intensity of 50 mW/cm² for varying durations, the reflection wavelengths of the resulting samples were tested at 25° C. using a liquid crystal comprehensive tester (DMS), and the differences in reflection wavelength relative to the non-UV-irradiated samples were then separately calculated.

n represents fluid viscosity. Testing method: Cone-and-plate viscometer testing at room temperature (25° C.) and an elevated temperature of 60° C. (the maximum heating temperature of an ODF device).

The preparation method for the cholesteric liquid crystal composition was as follows: Various liquid crystal monomers and a chiral agent were weighed at a certain ratio and then put into a stainless steel beaker, the stainless steel beaker containing these liquid crystal monomers was placed on a magnetic stirring instrument for heating and melting, a magnetic rotor was added to the stainless steel beaker when most of the liquid crystal monomers in the stainless steel beaker had melted, and the mixture was uniformly stirred and cooled to room temperature to obtain the liquid crystal composition.

The structures of the cholesteric liquid crystal monomers in the examples of the present invention are represented by codes, and the code representation method for liquid crystal ring structures, terminal groups, and linker groups is shown in Tables 3 and 4 below.

TABLE 3
Table of codes for structures

| | Corresponding |
|---|---|
| Ring structure | code |
| 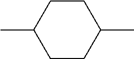 | C |
| 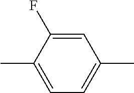 | Gi |
| 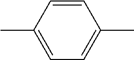 | P |
| 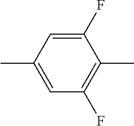 | U |
| 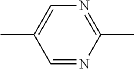 | Py |
| 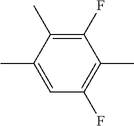 | K |
| 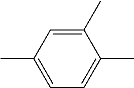 | M |
| 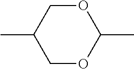 | D |
| 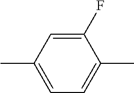 | G |

TABLE 4
Corresponding codes of terminal groups and linker groups

| Terminal groups | Corresponding |
|---|---|
| and linker groups | code |
| CₙH₂ₙ₊₁— | n- |
| CₙH₂ₙ₊₁O— | nO- |
| —OCₙH₂ₙ₊₁ | -On |
| —CF₂O— | -Q- |
| —CH₂O— | —O— |
| —O— | —B— |
| —F | —F |
| —CN | —N |
| —CH═CH— | —V— |
| —C≡C— | -T- |
| —COO— | -Z- |
| —CH═CH—CₙH₂ₙ₊₁ | -Vn |
| 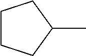 | Cp- |
| 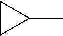 | Cpr- |
| 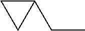 | Cpr1- |

For example:

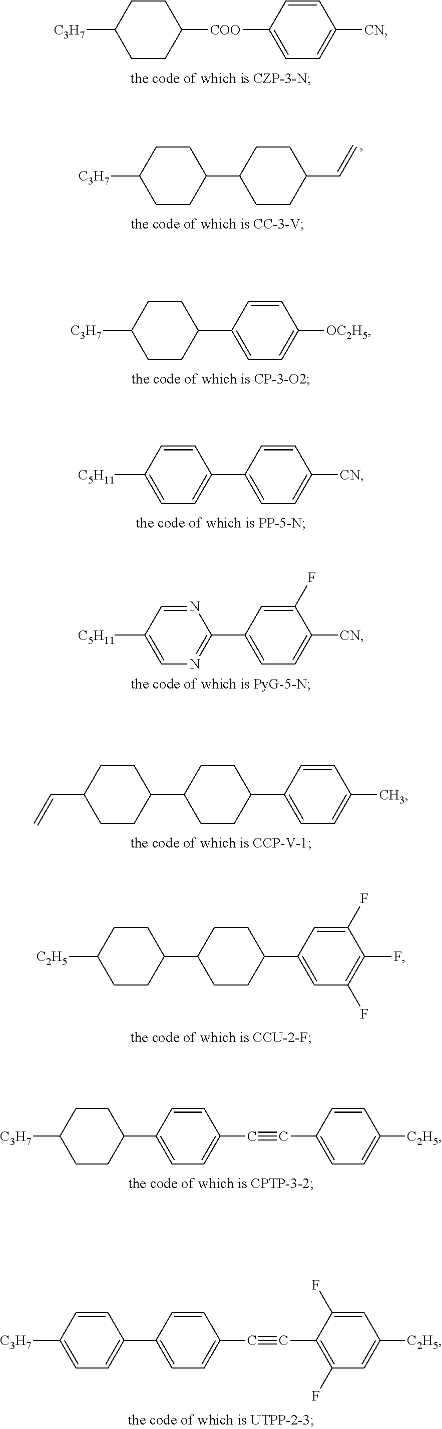

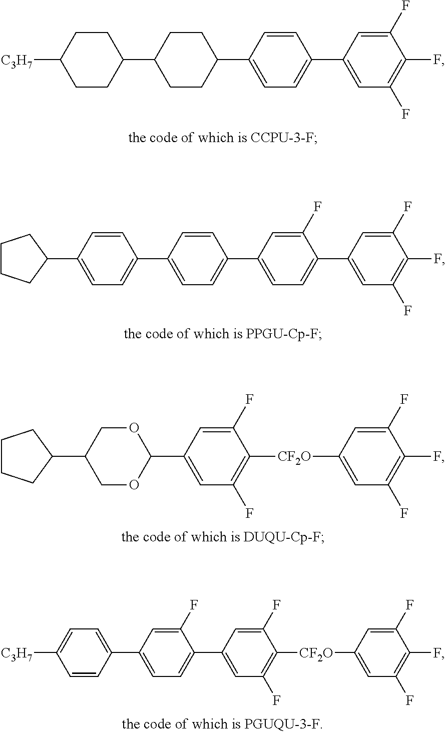

Liquid crystal compositions 1 to 5 were prepared according to the above method for later use. As shown in Table 5, those listed in Table 5 are only provided for example and do not represent a special limitation on the technical solution of the present application. The specific structure and mass percentage content of each component can be changed according to the actual test requirements.

TABLE 5

| No. | Structure | Composition 1 | Composition 2 | Composition 3 | Composition 4 | Composition 5 |
|---|---|---|---|---|---|---|
| I | UTPP-3-2 | 10 | 11 | 9 | 7 | 7 |
| I | UTPP-3-4 | 10 | 9 | 9 | 13 | 13 |
| I | UTPP-2-3 | 11 | 11 | 9 | 13 | 13 |
| I | UTPP-4-3 | 9 | 11 | 7 | 8 | 8 |
| II | PZG-2-N | 5 | 6 | 5 | 5 | 5 |
| II | PZG-3-N | 5 | 7 | 5 | 6 | 7 |
| II | PZG-4-N | 5 | 7 | 5 | 6 | 7 |
| II | PZG-5-N | | | | 6 | 7 |
| II | CPZG-3-N | | | | 3 | 2 |
| II | CPZG-4-N | | | | 2 | |
| II | CPZG-5-N | | | | 2 | |
| II | PZU-3-N | 4 | 4 | 4 | | 2 |
| II | PZU-5-N | 4 | 4 | 2 | | 3 |
| II | PZU-V 2-N | 8 | 8 | 6 | 13 | 13 |
| II | CCZU-2-N | 3 | | 2 | | |
| II | CCZU-3-N | 4 | | 4 | | |
| II | PGP-3-N | | | 6 | | |
| III | CCP-V-1 | | 7 | | 3 | 3 |
| III | CC-3-V | 7 | 7 | 3 | | |
| IV | CP-5-F | | | 4 | 2 | 2 |
| IV | PUQU-3-F | 11 | 8 | 6 | 3 | |
| IV | PGU-2-F | | | 5 | 4 | 4 |
| IV | PGU-3-F | | | 5 | 4 | 4 |
| V | CPP-3-2 | | | 4 | | |
| V | CPTP-3-2 | 4 | | | | |

| | | | | | |
|---|---|---|---|---|---|
| Tni [° C.] | 84 | 79 | 85 | 88 | 77 |
| Δn [589 nm, | 0.225 | 0.223 | 0.228 | 0.242 | 0.235 |
| 25° C.] | | | | | |
| Δε [1 KHz, | 38.3 | 36.4 | 33.8 | 46.1 | 50.6 |
| 25° C.] | | | | | |

A composition and a chiral agent were weighed at a certain ratio and then put into a stainless steel beaker, the stainless steel beaker containing various liquid crystal monomers was placed on a magnetic stirring instrument for heating and melting, a magnetic rotor was added to the stainless steel beaker when most of the liquid crystal monomers in the stainless steel beaker had melted, and the mixture was uniformly stirred and cooled to room temperature to obtain the cholesteric liquid crystal composition, as shown in Tables 6 and 7.

TABLE 6

| | | | Compar- | Compar- | Compar- | Compar- | Compar- | Compar- | Compar- | Compar- |
|---|---|---|---|---|---|---|---|---|---|---|
| | | | ative | ative | ative | ative | ative | ative | ative | ative |
| | Exam- | Exam- | Exam- | Exam- | Exam- | Exam- | Exam- | Exam- | Exam- | Exam- |
| | ple 1 | ple 2 | ple 1 | ple 2 | ple 3 | ple 4 | ple 5 | ple 6 | ple 7 | ple 8 |
| Composition | 93.0 | 94.5 | 92.5 | 92.0 | 93.0 | 92.1 | 93.5 | 93.2 | 93.0 | 94.2 |
| 1 (%) | | | | | | | | | | |
| Composition | | | | | | | | | | |
| 2 (%) | | | | | | | | | | |
| Composition | | | | | | | | | | |
| 3 (%) | | | | | | | | | | |
| Composition | | | | | | | | | | |
| 4 (%) | | | | | | | | | | |
| Composition | | | | | | | | | | |
| 5 (%) | | | | | | | | | | |
| Chiral agent | 7 | 4 | | | | | | | | |
| S1-1 (%) | | | | | | | | | | |
| Chiral agent | | 1.5 | | | | | | | | 1.8 |
| SA1 (%) | | | | | | | | | | |
| Chiral agent | | | | | | | | | | |
| SA6 (%) | | | | | | | | | | |
| Chiral agent | | | 7.5 | | | | | | | 4 |
| D1 (%) | | | | | | | | | | |
| Chiral agent | | | | 8 | | | | | | |
| D2 (%) | | | | | | | | | | |
| Chiral agent | | | | | 7 | | | 4 | 4 | |
| D3 (%) | | | | | | | | | | |
| Chiral agent | | | | | | 7.9 | | | 3 | |
| D4 (%) | | | | | | | | | | |
| Chiral agent | | | | | | | 6.5 | 2.8 | | |
| D5 (%) | | | | | | | | | | |
| Reflectance | 83.33 | 90.32 | 75.30 | 67.60 | 75.10 | 80.56 | — | 80.23 | 78.42 | 77.85 |
| retention | | | | | | | | | | |
| ratio (%) | | | | | | | | | | |
| Viscosity | 93.2 | 70 | 98.7 | 103.4 | 95.4 | 104.5 | 74.7 | 86.4 | 84.6 | 81.3 |
| (25° C.) | | | | | | | | | | |
| Viscosity | 20.2 | 14.3 | 25.6 | 28.9 | 22.7 | 27.5 | 14.8 | 19.5 | 18.8 | 17.8 |
| (60° C.) | | | | | | | | | | |
| UV-induced | 120 | 160 | 125 | 130 | 300 | 550 | — | 420 | 410 | 175 |
| color | | | | | | | | | | |
| switching | | | | | | | | | | |
| time (s) | | | | | | | | | | |
| Compatible | No | Yes | No | No | No | No | Yes | No | No | No |
| with ODF? | | | | | | | | | | |

TABLE 7

| | | | | Comparative | | | | | | |
|---|---|---|---|---|---|---|---|---|---|---|
| | Example 3 | Example 4 | Example 5 | Example 9 | Example 6 | Example 7 | Example 8 | Example 9 | Example 10 | Example 11 |
| Composition | 93.3 | | | | | | | | | |
| 1 (%) | | | | | | | | | | |
| Composition | | 94.7 | 93.5 | 94.5 | | | | | | |
| 2 (%) | | | | | | | | | | |
| Composition | | | | | 94.6 | 93.4 | | | | |
| 3 (%) | | | | | | | | | | |
| Composition | | | | | | | 94.3 | 93.1 | | |
| 4 (%) | | | | | | | | | | |
| Composition | | | | | | | | | 94.8 | 93.7 |
| 5 (%) | | | | | | | | | | |
| Chiral | 5 | 4 | 5 | | 4 | 5 | 4 | 5 | 4 | 5 |
| agent S1-1 | | | | | | | | | | |
| (%) | | | | | | | | | | |
| Chiral | 0.7 | 1.3 | 0.6 | 1.5 | 1.4 | 0.7 | 1.7 | 0.9 | 1.2 | 0.5 |
| agent SA1 | | | | | | | | | | |
| (%) | | | | | | | | | | |
| Chiral | 1 | | 0.9 | | | 0.9 | | 1 | | 0.8 |
| agent SA6 | | | | | | | | | | |
| (%) | | | | | | | | | | |
| Chiral | | | | 4 | | | | | | |
| agent D1 | | | | | | | | | | |
| (%) | | | | | | | | | | |
| Chiral | | | | | | | | | | |
| agent D2 | | | | | | | | | | |
| (%) | | | | | | | | | | |
| Chiral | | | | | | | | | | |
| agent D3 | | | | | | | | | | |
| (%) | | | | | | | | | | |
| Chiral | | | | | | | | | | |
| agent D4 | | | | | | | | | | |
| (%) | | | | | | | | | | |
| Chiral | | | | | | | | | | |
| agent D5 | | | | | | | | | | |
| (%) | | | | | | | | | | |
| Reflectance | 87.10 | 90.13 | 88.77 | 74.56 | 89.44 | 87.01 | 88.59 | 86.47 | 90.22 | 88.91 |
| retention | | | | | | | | | | |
| ratio (%) | | | | | | | | | | |
| Viscosity | 75.7 | 65.4 | 68.3 | 76.7 | 69 | 75.1 | 73.5 | 77.9 | 77.6 | 80.3 |
| (25° C.) | | | | | | | | | | |
| Viscosity | 14.5 | 12.8 | 13.1 | 16.7 | 13.9 | 14.3 | 14 | 14.9 | 14.5 | 15.1 |
| (60° C.) | | | | | | | | | | |
| UV-induced | 110 | 150 | 105 | 165 | 165 | 115 | 163 | 112 | 160 | 113 |
| color | | | | | | | | | | |
| switching | | | | | | | | | | |
| time (s) | | | | | | | | | | |
| Compatible | Yes | Yes | Yes | No | Yes | Yes | Yes | Yes | Yes | Yes |
| with | | | | | | | | | | |
| ODF? | | | | | | | | | | |

In summary, the cholesteric liquid crystal composition provided by the present invention has relatively high reflectance retention ratio while simultaneously achieving relatively low viscosity. The viscosities at especially 25° C. and 60° C. are both moderate, can be compatible with ODF dropwise addition. In addition, the cholesteric liquid crystal composition of the present invention has a fast UV-induced color switching speed and can reduce the production cost. Furthermore, a liquid crystal display element or liquid crystal display comprising the cholesteric liquid crystal composition of the present invention has relatively high reflectance retention ratio and less reflectance decrease during a photochromic process and simultaneously offers relatively fast response speed and relatively fast UV-induced color switching speed.

Apparently, the above examples of the present invention are only examples for clearly explaining the present invention and are not intended to limit the embodiments of the present invention. For those of ordinary skill in the pertinent field, other changes or variations in different forms may also be made on the basis of the above description. It is impossible to exhaust all the embodiments herein, and all derived obvious changes or variations that belong to the technical solution of the present invention still fall within the scope of protection of the present invention.

1. A chiral agent compound, characterized by being selected from the following formula S, 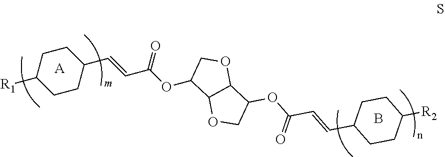
wherein
R₁ and R₂ each independently represent a fluoroalkyl group with a carbon atom number of 1-5, a fluoroalkoxy group with a carbon atom number of 1-5, a fluoroalkenyl group with a carbon atom number of 2-5, or a fluoroalkenyloxy group with a carbon atom number of 2-5; 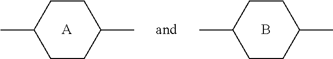
each independently represent 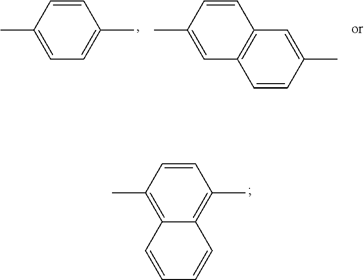
and any hydrogen of 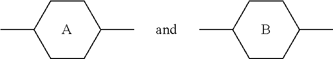
can be replaced by a halogen, an alkyl group with a carbon atom number of 1-10, an alkoxy group with a carbon atom number of 1-10, an alkenyl group with a carbon atom number of 2-10, or an alkenyloxy group with a carbon atom number of 2-10; and
m and n each independently represent 1 or 2.

2. The chiral agent compound according to claim 1, characterized in that the chiral agent S is selected from the group consisting of compounds represented by the following formulas S1 to S18: 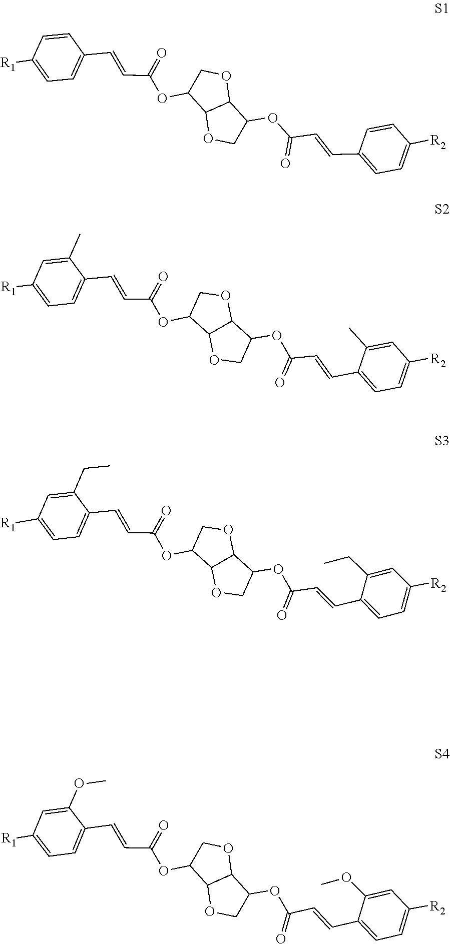 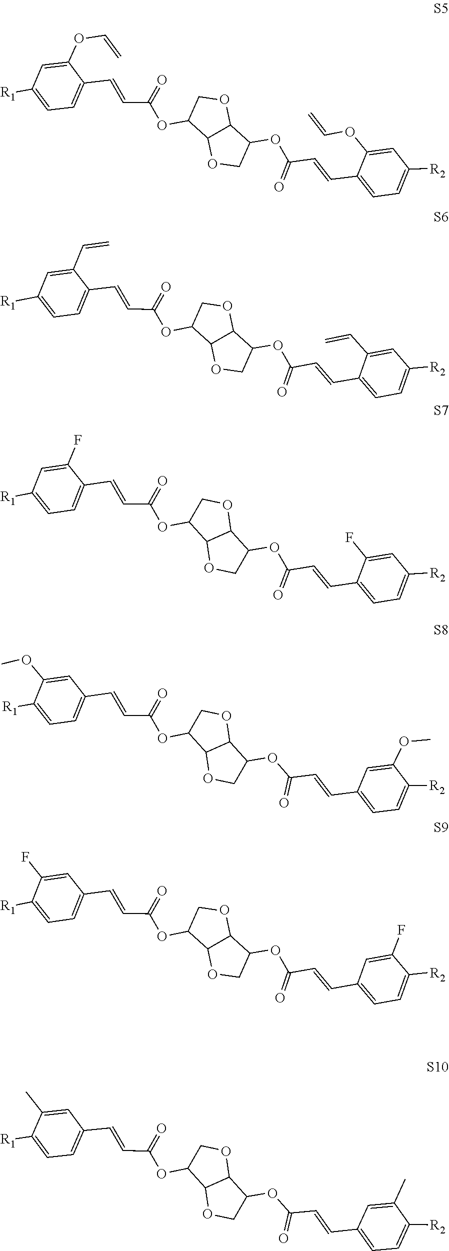 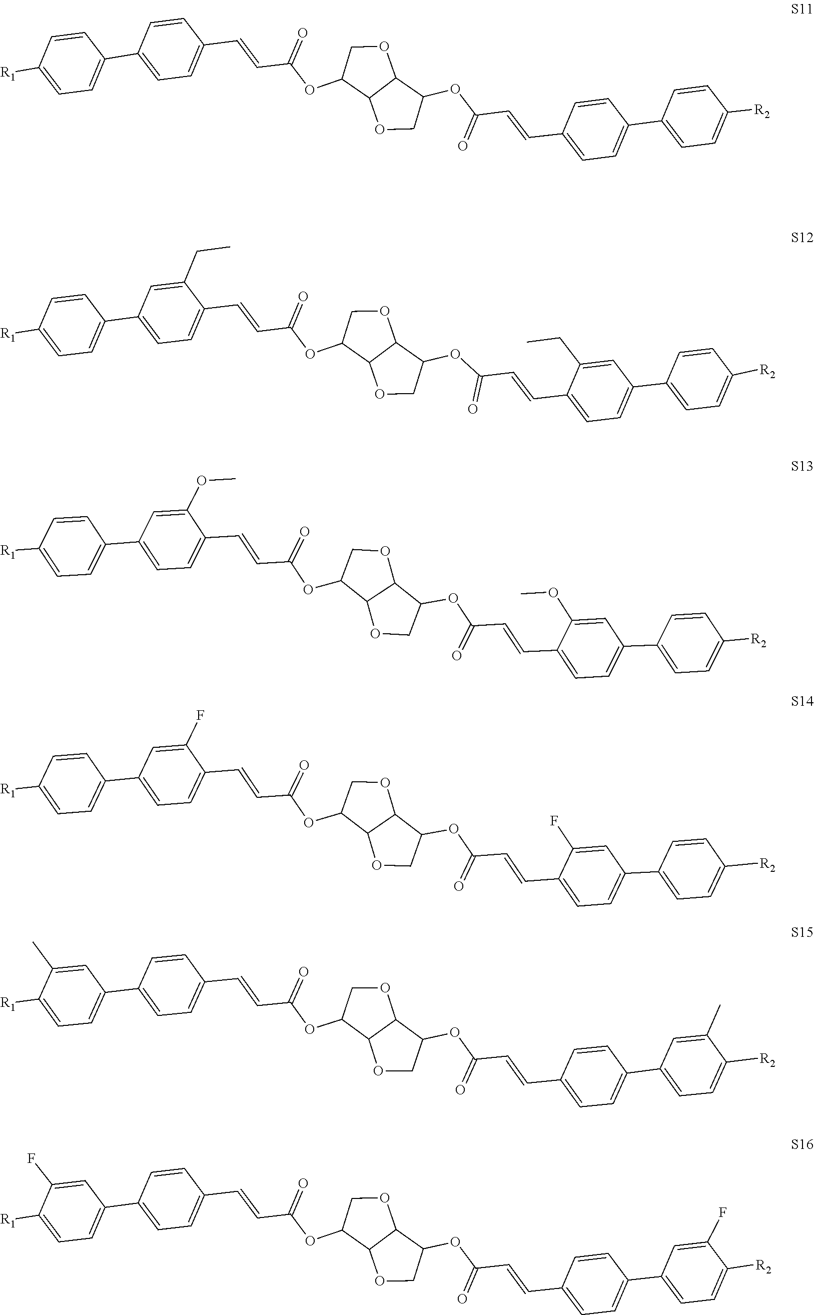 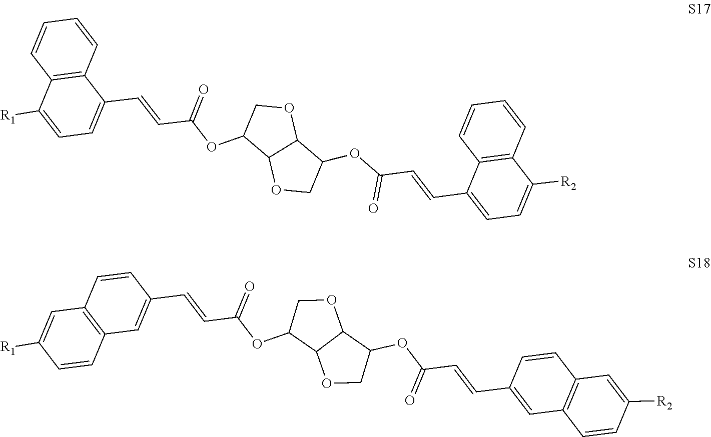
wherein
R₁ and R₂ each independently represent a fluoroalkyl group with a carbon atom number of 1-5, a fluoroalkoxy group with a carbon atom number of 1-5, a fluoroalkenyl group with a carbon atom number of 2-5, or a fluoroalkenyloxy group with a carbon atom number of 2-5.

3. The chiral agent compound according to claim 2, characterized in that the chiral agents S1 to S18 is selected from the group consisting of compounds represented by the following formulas S1-1 to S18-2:

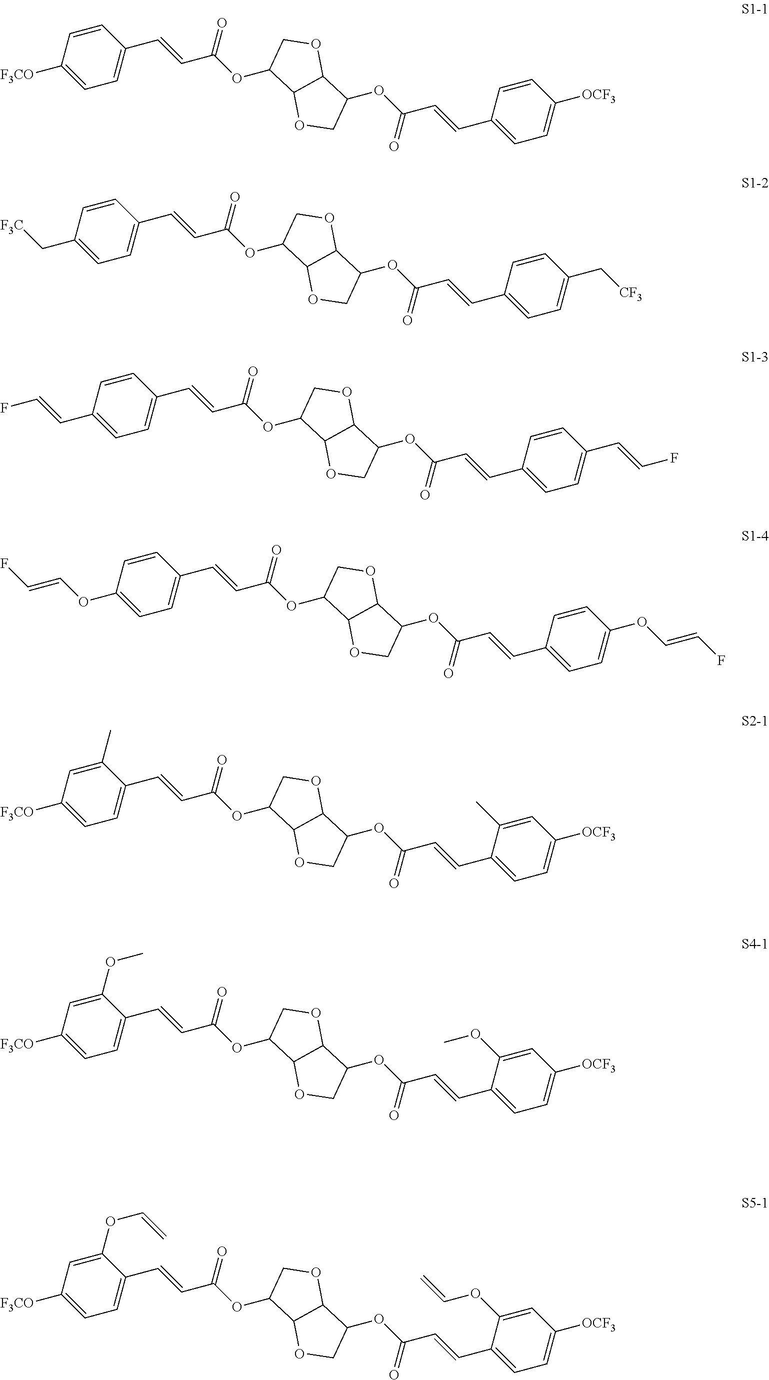

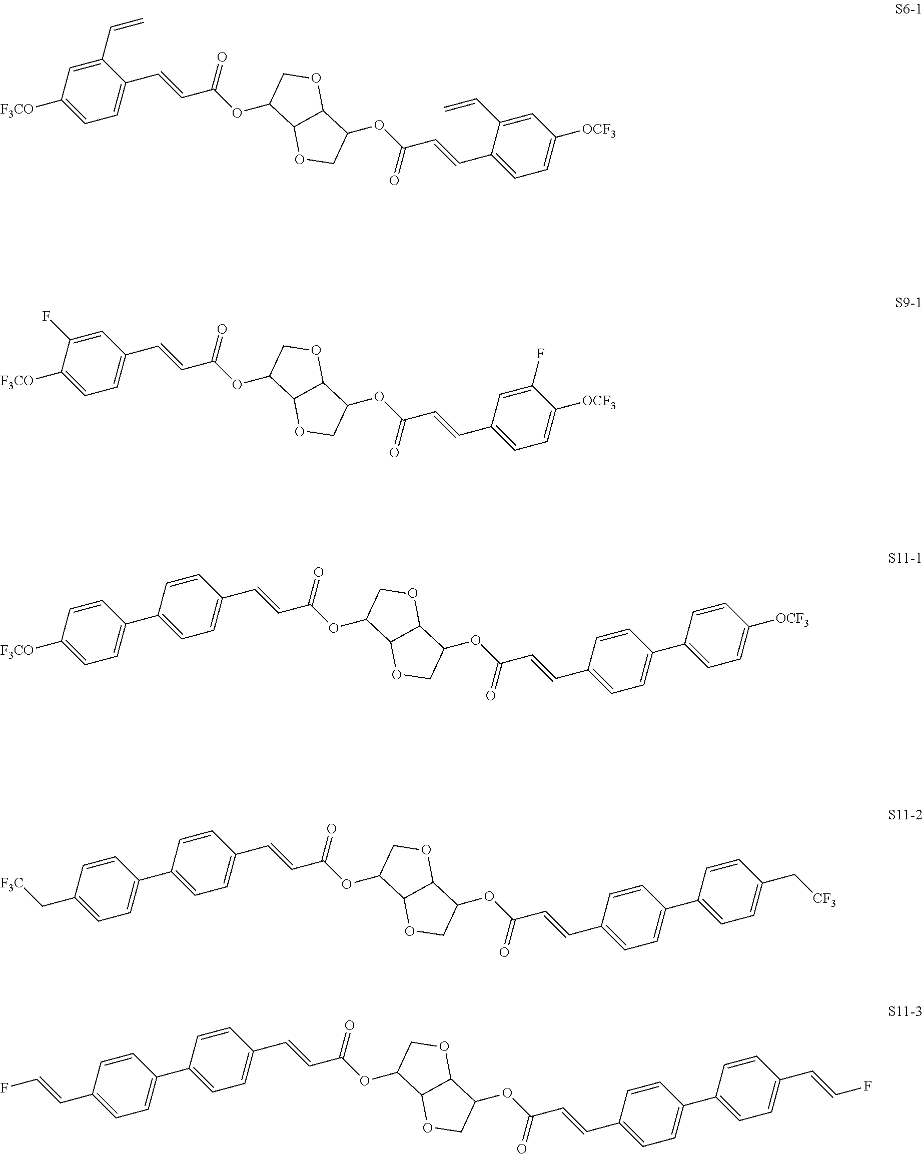 [SMILES: C=Cc1cc(OC(F)(F)F)ccc1/C=C/C(=O)OC1COC2C(OC(=O)/C=C/c3ccc(OC(F)(F)F)cc3C=C)COC12 ; O=C(/C=C/c1ccc(OC(F)(F)F)c(F)c1)OC1COC2C(OC(=O)/C=C/c3ccc(OC(F)(F)F)c(F)c3)COC12 ; O=C(/C=C/c1ccc(-c2ccc(OC(F)(F)F)cc2)cc1)OC1COC2C(OC(=O)/C=C/c3ccc(-c4ccc(OC(F)(F)F)cc4)cc3)COC12 ; O=C(/C=C/c1ccc(-c2ccc(CC(F)(F)F)cc2)cc1)OC1COC2C(OC(=O)/C=C/c3ccc(-c4ccc(CC(F)(F)F)cc4)cc3)COC12 ; O=C(/C=C/c1ccc(-c2ccc(/C=C/F)cc2)cc1)OC1COC2C(OC(=O)/C=C/c3ccc(-c4ccc(/C=C/F)cc4)cc3)COC12]

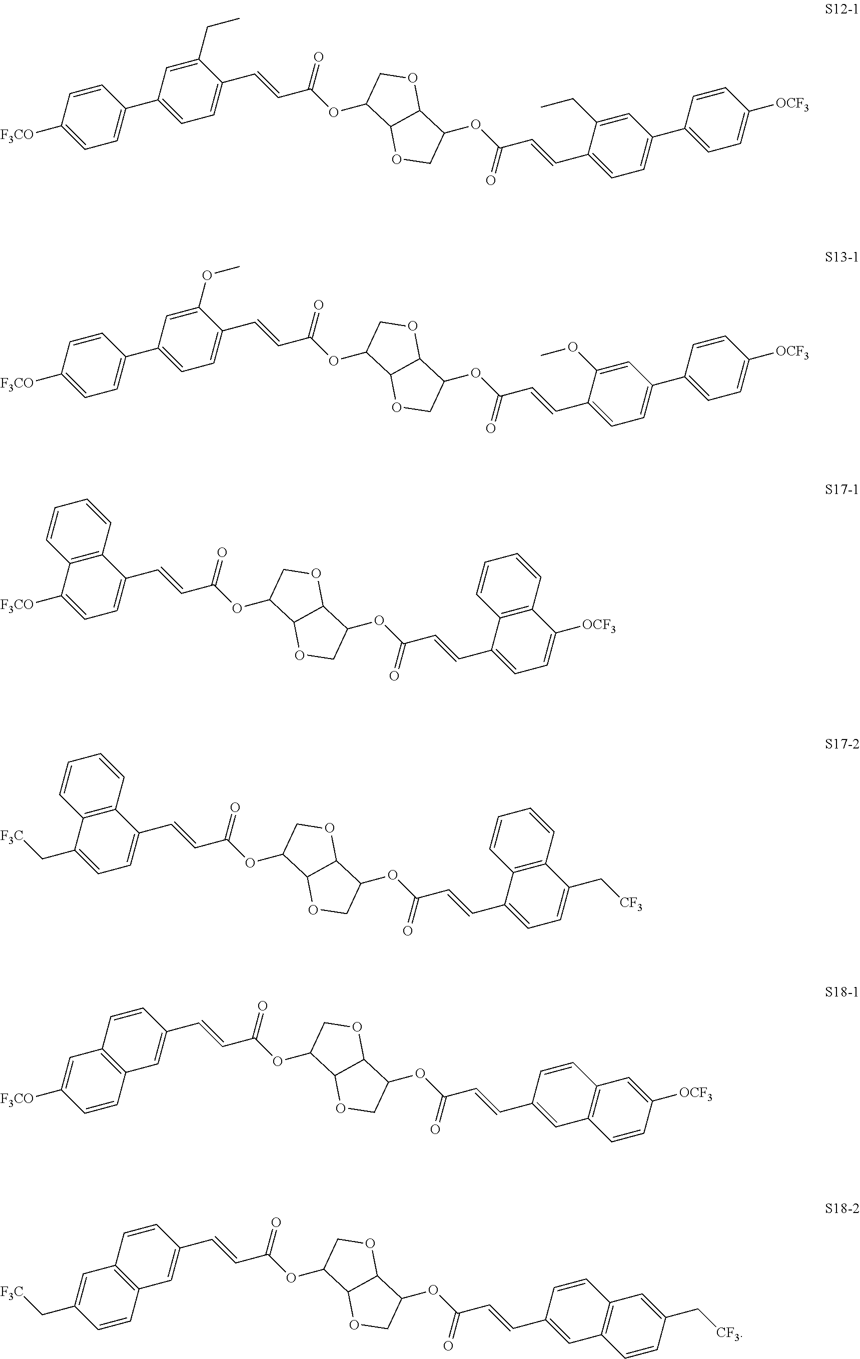

4. A cholesteric liquid crystal composition, characterized in that the cholesteric liquid crystal composition comprises one or more chiral agent compounds selected from the chiral agent compounds represented by formula S as defined in claim 1.

5. The cholesteric liquid crystal composition according to claim 4, characterized in that the cholesteric liquid crystal composition at least comprises a chiral agent compound represented by formula S1-1.

6. The cholesteric liquid crystal composition according to claim 4, characterized in that the cholesteric liquid crystal composition further comprises one or more chiral agent compounds represented by formulas SA1 to SA5, 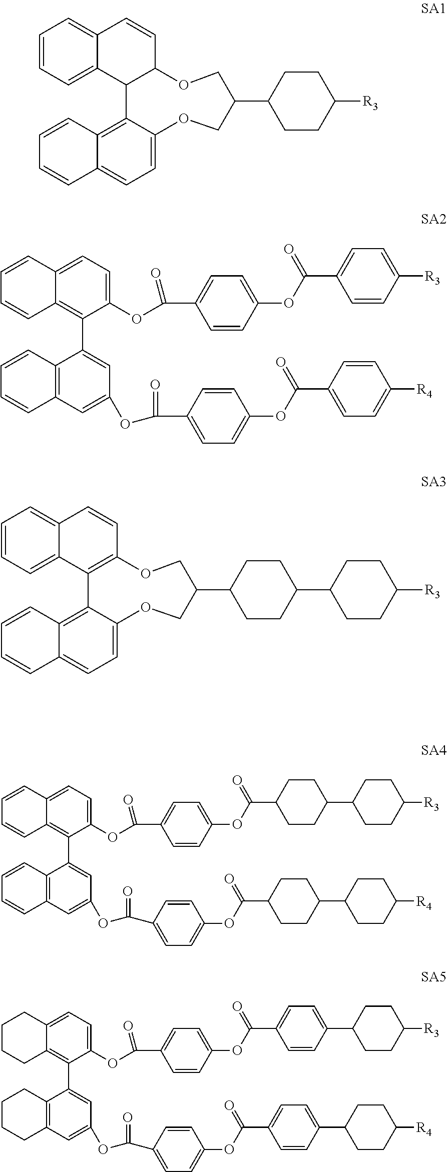
wherein
R₃ and R₄ each independently represent an alkyl group with a carbon atom number of 1-6, a fluorine-substituted alkyl group with a carbon atom number of 1-6, an alkoxy group with a carbon atom number of 1-6, a fluorine-substituted alkoxy group with a carbon atom number of 1-6, an alkenyl group with a carbon atom number of 2-6, a fluorine-substituted alkenyl group with a carbon atom number of 2-6, an alkenyloxy group with a carbon atom number of 3-8, or an fluorine-substituted alkenyloxy group with a carbon atom number of 3-8.

7. The cholesteric liquid crystal composition according to claim 6, characterized in that the cholesteric liquid crystal composition comprises a chiral agent compound represented by formula S1-1 and at least one of chiral agent compounds represented by formulas SA1 to SA5.

8. The cholesteric liquid crystal composition according to claim 7, characterized in that the mass percentage content of chiral agent compound S1-1 is 2-6%, and the mass percentage content of chiral agent compounds SA1 to SA5 is 0.1-3%.

9. The cholesteric liquid crystal composition according to claim 8, characterized in that the cholesteric liquid crystal composition further comprises one or more compounds represented by formula I, one or more compounds represented by formula II, one or more compounds represented by formula III, and one or more compounds represented by formula IV, 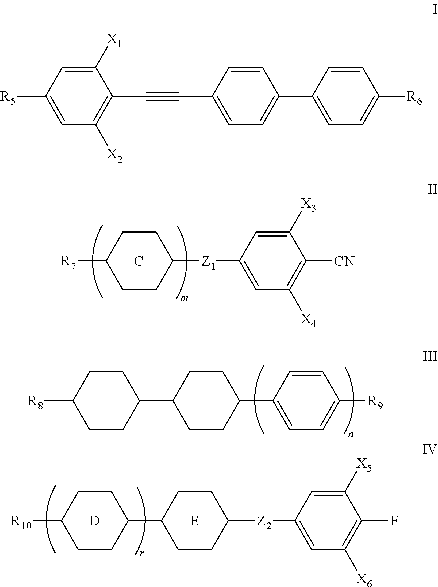
wherein
R₅, R₆, R₉, and R₁₀ each independently represent an alkyl group with a carbon atom number of 1-10; and one or more non-adjacent —CH₂— in R₁₀ can be replaced by cyclopentylene or cyclopropylene;
R₇ represents an alkyl group with a carbon atom number of 1-10 or an alkenyl group with a carbon atom number of 2-10;
R₈ represents an alkenyl group with a carbon atom number of 2-10;
X₁, X₂, X₃, X₄, X₅, and X₆ each independently represent H or F;
m represents 1, 2, or 3;
n represents 0 or 1;
r represents 0, 1, or 2;
Z₁ represents a single bond, —COO—, or —OCO—;
Z₂ represents a single bond, —COO—, —OCO—, —OCF₂—, or —CF₂O—; and 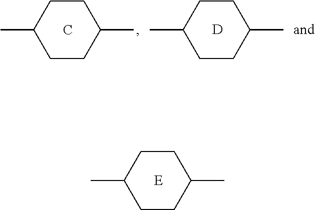
each independently represent

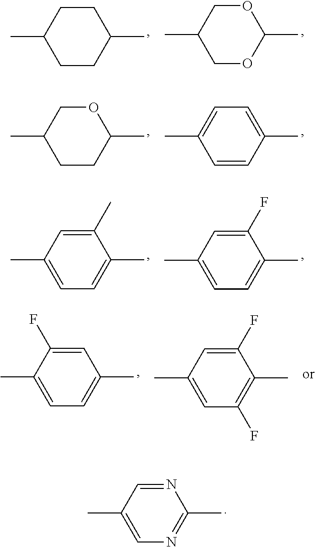

10. The cholesteric liquid crystal composition according to claim 9, characterized in that the cholesteric liquid crystal composition further comprises one or more compounds represented by formula V, 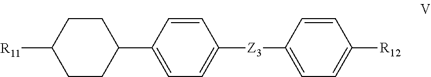
wherein
R₁₁ and R₁₂ each independently represent an alkyl group with a carbon atom number of 1-10; and
Z₃ represents a single bond or —C≡C—.

11. A cholesteric liquid crystal display element, characterized by comprising the cholesteric liquid crystal composition according to claim 1, wherein the cholesteric liquid crystal display element is an active matrix addressed display element or a passive matrix addressed display element.

12. A cholesteric liquid crystal display, characterized by comprising the cholesteric liquid crystal composition according to claim 1, wherein the cholesteric liquid crystal display is an active matrix addressed display or a passive matrix addressed display.
